(19) United States
(12) Patent Application Publication
(10) Pub. No.: US 2021/0288693 A1
(43) Pub. Date: Sep. 16, 2021

(54) COMMUNICATION DEVICE, COMMUNICATION METHOD, AND ELECTRONIC DEVICE

(71) Applicant: SONY SEMICONDUCTOR SOLUTIONS CORPORATION

(72) Inventors: TAKAHIRO TAKEDA, KANAGAWA (JP); YASUHIRO OKADA, KANAGAWA (JP)

(21) Appl. No.: 16/321,456

(22) PCT Filed: Sep. 14, 2017
(86) PCT No.: PCT/JP2017/033204

§ 371 Date: Jan. 28, 2019

(30) Foreign Application Priority Data
Sep. 27, 2016 (JP) 2016-188258

(51) Int. Cl. H04B 5/02; H01Q 13/20; H01P 1/04

(52) U.S. Cl. CPC H04B 5/02; H04B 5/0075; H01P 1/042; H01Q 13/20

(57) ABSTRACT

The present technology relates to a communication device, a communication method, and an electronic device which are capable of suppressing the leak of an electromagnetic wave to the outside of housings in a case where two communication devices perform communication in a state in which housings thereof are brought into contact with or close to each other. The electronic device includes: a waveguide tube that includes a choke structure nearby an opening end and transmits a signal in a state in which the opening end is in contact with or close to an opening end of another waveguide tube; and a transmitting unit that transmits a transmission signal via the waveguide tube and controls a relative relation between a transmission frequency of the transmission signal and a frequency characteristic of the choke structure. The present technology can be applied to, for example, communication devices that transmit millimeter wave signals.

### TECHNICAL FIELD

The present technology relates to a communication device, a communication method, and an electronic device, and more particularly to, a communication device, a communication method, and an electronic device which are capable of performing communication in a state in which a housing are in contact with or close to another communication device.

### BACKGROUND ART

There is a communication system in which two communication devices perform communication in a state in which housings (device main bodies) thereof are brought into contact with or close to each other. As an example of this type of communication system, a communication system in which one of two communication devices is a mobile terminal device, and the other communication device is a wireless communication device called a cradle is known (see, for example, Patent Document 1).

### CITATION LIST

### Patent Document

Patent Document 1: Japanese Patent Application Laid-Open No. 2006-65700

### SUMMARY OF THE INVENTION

### Problems to be Solved by the Invention

In the communication system in which two communication devices perform communication in a state in which housings (device main bodies) thereof are brought into contact with or close to each other, it is important to prevent an electromagnetic wave from leaking to the outside of the housing from a viewpoint of transmission characteristic, a viewpoint of interference to other devices, or the like. However, in the communication system according to the example of the related art disclosed in Patent Document 1, there is a problem in that since wireless communication using a slot antenna is performed, and the electromagnetic wave is likely to leak to the outside of the housing, the transmission characteristic degrades. This point (problem) is apparent from the fact that an electromagnetic wave absorber is arranged around the housing to prevent the leak of the electromagnetic wave in the third example of Patent Document 1.

The present technology was made in light of the foregoing, and it is desirable to suppress the leak of the electromagnetic wave to the outside of the housings in a case where two communication devices perform communication in a state in which housings thereof are brought into contact with or close to each other.

### Solutions to Problems

A communication device according to a first aspect of the present technology includes: a first waveguide tube that includes a choke structure nearby an opening end and transmits a signal in a state in which the opening end is in contact with or close to an opening end of a first other waveguide tube; and a transmitting unit that transmits a transmission signal via the first waveguide tube and controls a relative relation between a transmission frequency of the transmission signal and a frequency characteristic of the choke structure.

It is possible to cause the transmitting unit to adjust the transmission frequency on the basis of at least one of a level of a leakage electromagnetic wave which is an electromagnetic wave leaking between the first waveguide tube and the first other waveguide tube or a distance between the first waveguide tube and the first other waveguide tube.

It is possible to cause the transmitting unit to set the transmission frequency to be near a frequency at which an effect of reducing the leakage electromagnetic wave by the choke structure is highest at the distance between the first waveguide tube and the first other waveguide tube.

It is possible to cause the transmitting unit to further adjust a gain of an amplifier that amplifies the transmission signal on the basis of the level of the leakage electromagnetic wave.

It is possible to further dispose a second waveguide tube that transmits a signal in a state in which the opening end is in contact with or close to the opening end of a second other waveguide tube and a receiving unit that receives a signal via the second waveguide tube and cause the transmitting unit to adjust the transmission frequency on the basis of the level of the leakage electromagnetic wave received via the second waveguide tube by the receiving unit.

It is possible to further dispose a first measuring unit that measures the level of the leakage electromagnetic wave.

It is possible to further dispose a second measuring unit that measures the distance between the first waveguide tube and the first other waveguide tube.

It is possible to fill a groove of the choke structure with a dielectric including a dielectric constant-variable material and cause the transmitting unit to adjust a dielectric constant of the dielectric.

It is possible to cause the transmitting unit to adjust the dielectric constant of the dielectric on the basis of at least one of a level of a leakage electromagnetic wave which is an electromagnetic wave leaking between the first waveguide tube and the first other waveguide tube or a distance between the first waveguide tube and the first other waveguide tube.

It is possible to cause the transmitting unit to set the dielectric constant of the dielectric to be near a dielectric constant at which an effect of reducing the leakage electromagnetic wave by the choke structure is highest at the distance between the first waveguide tube and the first other waveguide tube and the transmission frequency.

It is possible to cause the transmitting unit to further adjust a gain of an amplifier that amplifies the transmission signal on the basis of the level of the leakage electromagnetic wave.

It is possible to further dispose a second waveguide tube that transmits a signal in a state in which the opening end is in contact with or close to the opening end of a second other waveguide tube and a receiving unit that receives a signal via the second waveguide tube and cause the transmitting unit to adjust the dielectric constant of the dielectric on the basis of the level of the leakage electromagnetic wave received via the second waveguide tube by the receiving unit.

It is possible to further dispose a first measuring unit that measures the level of the leakage electromagnetic wave.

It is possible to further dispose a second measuring unit that measures the distance between the first waveguide tube and the first other waveguide tube.

It is possible to cause the transmitting unit to adjust the dielectric constant of the dielectric by adjusting a voltage to be applied to the dielectric.

A depth of a groove of the choke structure may be about ¼ of a wavelength of the transmission signal.

The transmission signal may be a signal of a millimeter wave band.

A communication method according to a second aspect of the present technology includes: controlling, by a communication device including a waveguide tube including a choke structure nearby an opening end, a relative relation between a transmission frequency of a transmission signal and a frequency characteristic of the choke structure in a case where the transmission signal is transmitted from the waveguide tube to another waveguide tube in a state in which the opening end of the waveguide tube is in contact with or close to an opening end of the other waveguide tube.

An electronic device according to a third aspect of the present technology includes: a waveguide tube that includes a choke structure nearby an opening end and transmits a signal in a state in which the opening end is in contact with or close to an opening end of another waveguide tube; and a transmitting unit that transmits a transmission signal via the waveguide tube and controls a relative relation between a transmission frequency of the transmission signal and a frequency characteristic of the choke structure.

In the first aspect or the third aspect of the present technology, the transmission signal is transmitted via the waveguide tube, and the relative relation between the transmission frequency of the transmission signal and the frequency characteristic of the choke structure is controlled.

In the second aspect of the present technology, a relative relation between a transmission frequency of a transmission signal and a frequency characteristic of the choke structure is controlled in a case where the transmission signal is transmitted from the waveguide tube to another waveguide tube in a state in which the opening end of the waveguide tube is in contact with or close to an opening end of the other waveguide tube.

### Effects of the Invention

According to the first to third aspects of the present technology, it is possible to suppress the leak of the electromagnetic wave to the outside of the housing in a case where two communication devices perform communication in a state in which housings thereof are brought into contact with or close to each other.

Further, the effects described herein are not necessarily limited, and any effect described in this description may be included. Further, the effect described in this description is merely an example, and the present technology is not limited thereto, and additional effects may be included.

### BRIEF DESCRIPTION OF DRAWINGS

FIG. 1 is a plan view including a partial cross section of a communication device according to a first embodiment of the present technology.

FIG. 2 is a block diagram illustrating an example of a specific configuration of a transmitting unit of FIG. 1.

FIG. 3 is a block diagram illustrating an example of a specific configuration of a receiving unit of FIG. 1.

FIG. 4 is a perspective view illustrating an example of a configuration of a transmission path portion of a waveguide tube.

FIG. 5 is a plane cross-sectional view illustrating a configuration of each coupling portion of two waveguide tubes of a connector device according to a first example of the first embodiment.

FIG. 6 is an arrow cross-sectional view illustrating a configuration of each of the coupling portions of the two waveguide tubes of the connector device according to the first example of the first embodiment.

FIG. 7 is a side cross-sectional view illustrating a configuration of each of the coupling portions of the two waveguide tubes of the connector device according to the first example of the first embodiment.

FIG. 8 is a diagram illustrating a transmission characteristic between the two waveguide tubes of the connector device according to the first example of the first embodiment.

FIG. 9 is a plane cross-sectional view illustrating a configuration of each coupling portion of two waveguide tubes of a connector device according to a second example of the first embodiment.

FIG. 10 is a plane cross-sectional view illustrating a configuration of each coupling portion of two waveguide tubes of a connector device according to a third example of the first embodiment.

FIG. 11 is a plane cross-sectional view illustrating a configuration of each coupling portion of two waveguide tubes of a connector device according to a fourth example of the first embodiment.

FIG. 12 is a diagram illustrating a configuration of each coupling portion of two waveguide tubes of a connector device according to a fifth example of the first embodiment.

FIG. 13 is a diagram illustrating a configuration of each coupling portion of two waveguide tubes of a connector device according to a sixth example of the first embodiment.

FIG. 14 is a diagram illustrating a structure of a waveguide tube according to a modified example of the fifth and sixth examples of the first embodiment.

FIG. 15 is a diagram illustrating a case where there is a deviation between central axes of two coupling portions, and there is a gap between coupling portions in a connector device according to the first example of the first embodiment.

FIG. 16 is a diagram illustrating a transmission characteristic in a case where there is a deviation between central axes of two coupling portions, and there is a gap between coupling portions in a connector device according to the first example of the first embodiment.

FIG. 17 is a diagram illustrating an example of a configuration of a choke structure of a connector device according to a seventh example of the first embodiment.

FIG. 18 is a diagram illustrating a transmission characteristic between two waveguide tubes of a connector device according to the seventh example of the first embodiment.

FIG. 19 is a side cross-sectional view illustrating another configuration of each coupling portion of two waveguide tubes of a connector device according to an eighth example of the first embodiment.

FIG. 20 is a graph illustrating an example of a frequency characteristic of a choke structure with respect to a distance between connectors.

FIG. 21 is a plan view including a partial cross section of a first example of a communication device according to a second embodiment of the present technology.

FIG. 22 is a block diagram illustrating an example of a specific configuration of a transmitting unit of FIG. 21.

FIG. 23 is a flowchart for describing a first example of a noise reduction process of a communication device of FIG. 20.

FIG. 24 is a flowchart for describing a second example of the noise reduction process of the communication device of FIG. 20.

FIG. 25 is a flowchart for describing a third example of the noise reduction process of the communication device of FIG. 20.

FIG. 26 is a flowchart for describing a fourth example of the noise reduction process of the communication device of FIG. 20.

FIG. 27 is a flow chart for describing a fifth example of the noise reduction process of the communication device of FIG. 20.

FIG. 28 is a flowchart for describing a sixth example of the noise reduction process of the communication device of FIG. 20.

FIG. 29 is a flowchart for describing a seventh example of the noise reduction process of the communication device of FIG. 20.

FIG. 30 is a plan view including a partial cross section of a second example of the communication device according to the second embodiment of the present technology.

FIG. 31 is a flowchart for describing a first example of a noise reduction process of a communication device of FIG. 30.

FIG. 32 is a flowchart for describing a second example of the noise reduction process of the communication device of FIG. 30.

FIG. 33 is a plan view including a partial cross section of a third example of the communication device according to the second embodiment of the present technology.

FIG. 34 is a graph illustrating an example of a frequency characteristic of a choke structure with respect to a dielectric constant of a dielectric in a case where a distance between connectors is 1.0 mm.

FIG. 35 is a graph illustrating an example of a frequency characteristic of a choke structure with respect to a dielectric constant of a dielectric in a case where a distance between connectors is 1.5 mm.

FIG. 36 is a graph illustrating an example of a frequency characteristic of a choke structure with respect to a dielectric constant of a dielectric in a case where a distance between connectors is 2.0 mm.

FIG. 37 is a plan view including a partial cross section of a first example of a communication device according to a third embodiment of the present technology.

FIG. 38 is a block diagram illustrating an example of a specific configuration of a transmitting unit of FIG. 37.

FIG. 39 is a diagram illustrating a connection example of a variable power source of FIG. 37.

FIG. 40 is a flowchart for describing a first example of a noise reduction process of a communication device of FIG. 37.

FIG. 41 is a flowchart for describing a second example of the noise reduction process of the communication device of FIG. 37.

FIG. 42 is a flowchart for describing a third example of the noise reduction process of the communication device of FIG. 37.

FIG. 43 is a flow chart for describing a fourth example of the noise reduction process of the communication device of FIG. 37.

FIG. 44 is a flowchart for describing a fifth example of the noise reduction process of the communication device of FIG. 37.

FIG. 45 is a plan view including a partial cross section of a second example of the communication device according to the third embodiment of the present technology.

FIG. 46 is a flowchart for describing a first example of a noise reduction process of a communication device of FIG. 45.

FIG. 47 is a flowchart for describing a second example of the noise reduction process of the communication device of FIG. 45.

FIG. 48 is a plan view including a partial cross section of a third example of the communication device according to the third embodiment of the present technology.

### MODE FOR CARRYING OUT THE INVENTION

Hereinafter, modes (hereinafter referred to as “embodiments”) for carrying out the present technology will be described in detail with reference to the appended drawings. Further, the present technology is not limited to the following embodiments, and various numerical values, materials, or the like in the following embodiments are examples. In the following description, the same reference numerals are used to denote the same elements or elements having the same function, and redundant description will be omitted appropriately. Further, the description will proceed in the following order.

1. Overall description of the present technology

2. First Embodiment

2-1. First example

2-2. Second example (modified example of first example: example in which choke structure is disposed only on transmitting side)

2-3. Third example (modified example of first example: example in which choke structure is disposed only on receiving side)

2-4. Fourth example (modified example of first example: example in which choke structure is not filled with dielectric)

2-5. Fifth example (example in which two-way communication is possible: example in which waveguides are arranged horizontally)

2-6. Sixth example (modified example of fifth example: example in which waveguides are stacked vertically)

2-7. Degradation in transmission characteristic associated with misalignment between two coupling portions or the like

2-8. Seventh example (modified example of first example: modified example of choke structure)

2-9. Eighth example (modified example of first example: example in which insulating layer is omitted)

3. Second Embodiment

3-1. Frequency characteristic of choke structure with respect to distance between connectors

3-2. First example

3-3. Second example (modified example of first example: example using distance sensor)

3-4. Third example (modified example of first example: example in which receiving unit is disposed)

4. Third Embodiment

4-1. Frequency characteristic of choke structure with respect to distance between connectors and dielectric constant of dielectric

4-2. First example

4-3. Second example (modified example of first example: example using distance sensor)

4-4. Third example (modified example of first example: example in which receiving unit is disposed)

5. Modified example

6. Specific examples of communication system

### 1. Overall Description of the Present Technology

In the present technology, a radio frequency signal such as an electromagnetic wave, particularly, a microwave, a millimeter wave, or a terahertz wave can be used as a signal for performing communication between two communication devices (two waveguide tubes). A communication system using a radio frequency signal is suitable for transmission of signals between various kinds of devices, transmission of signals between circuit boards in a single device (apparatus), and the like.

Further, it is desirable to use a signal of a millimeter wave band among the radio frequency signals as the signal for performing communication between two communication devices. The signal of the millimeter wave band is an electromagnetic wave having a frequency of 30 [GHz] to 300 [GHz] (a wavelength of 1 [mm] to 10 [mm]). If signal transmission (communication) is performed at a millimeter wave band, it is possible to realize high-speed signal transmission of a Gbps order (for example, 5 [Gbps] or more). As a signal that requires high-speed signal transmission of the Gbps order, for example, there is a data signal such as a movie image or a computer image. Further, there are advantages in that the signal transmission at the millimeter wave band is excellent in interference resistance, and it does not interfere with other electrical wirings in cable connection between devices.

### 2. First Embodiment

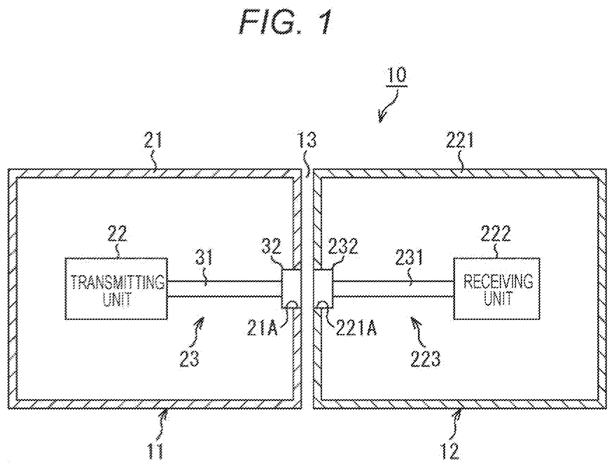

A first embodiment of the present technology will now be described with reference to FIGS. 1 to 19.

### First Example

First, a first example of the first embodiment of the present technology will be described with reference to FIGS. 1 to 8.

FIG. 1 is a plan view including a partial cross section illustrating an example of a configuration of a communication system according to the first embodiment of the present technology. A communication system 10 according to the present example has a configuration in which different communication devices, specifically, a communication device 11 and a communication device 12 perform communication via transmission paths of a plurality of systems in a state in which houses (device main bodies) thereof are brought into contact with or close to each other. In the present example, the communication device 11 serves as a communication device on a transmitting side, and the communication device 12 serves as a communication device on a receiving side.

The communication device 11 has a configuration in which a transmitting unit 22 and a waveguide tube 23 are accommodated in a housing 21. The communication device 12 has a configuration in which a receiving unit 222 and a waveguide tube 223 are accommodated in a housing 221. The housing 21 of the communication device 11 and the housing 221 of the communication device 12 have, for example, a rectangular shape and include a dielectric, for example, resin having a dielectric constant of 3 and a thickness of about 0.2 [mm]. In other words, the housing 21 of the communication device 11 and the housing 221 of the communication device 12 are resinous housings. However, the housing 21 and the housing 221 are not limited to resinous housings.

In the communication system 10 including the communication device 11 and the communication device 12, the communication device 11 and the communication device 12 perform communication using radio frequency signal, for example, the signal of the millimeter wave band, preferably, in a state in which planes of the housing 21 and the housing 221 are brought into contact with or close to each other. Here, in the term “close,” a state in which a distance between the two communication devices 11 and 12 is shorter than a distance between communication devices typically used in broadcasting or common wireless communication as long as a transmission range of the signal of the millimeter wave band can be limited since the radio frequency signal is the signal of the millimeter wave band corresponds to a state in which they is brought close to each other. More specifically, the term “close” refers to a state in which a distance (interval) between the communication device 11 and the communication device 12 is 10 [cm] or less, preferably, 1 [cm] or less.

In the communication device 11, the waveguide tube 23 forming a transmission path in which the signal of the millimeter wave band transmitted from the transmitting unit 22 is transmitted is disposed between an opening 21A formed on a wall plate on the communication device 12 side of the housing 21 and an output terminal of the transmitting unit 22. In the communication device 12, similarly, the waveguide tube 223 forming a transmission path in which the received signal of the millimeter wave band is transmitted is disposed between an opening 221A formed on a wall plate on the communication device 11 side of the housing 221 and an input terminal of the receiving unit 222.

The waveguide tube 23 on the communication device 11 side includes a transmission path portion 31 for transmitting the signal of the millimeter wave band transmitted from the transmitting unit 22 and a coupling portion 32 disposed at the end of the transmission path portion 31. The coupling portion 32 is disposed to be exposed in one side of the housing 21 via the opening 21A of the housing 21. At this time, an end surface of an opening end of the coupling portion 32 is preferably on the same plane as an outer wall surface of the housing 21. The waveguide tube 223 on the communication device 12 side includes a transmission path portion 231 for transmitting the signal of the millimeter wave band to the receiving unit 222 and a coupling portion 232 disposed at the end of the transmission path portion 231. The coupling portion 232 is disposed to be exposed in one side of the housing 221 via the opening 221A of the housing 221. At this time, the end surface of the opening end of the coupling portion 232 is preferably on the same plane as an outer wall surface of the housing 221.

The waveguide tube 23 on the communication device 11 side and the waveguide tube 223 on the communication device 12 side are arranged in a state in which the opening end of the coupling portion 32 and the opening end of the coupling portion 232 are in contact with or close to each other. Ina state in which the opening ends of the coupling portions 32 and 232 are close to each other, an air layer 13 is interposed between the end surfaces of both opening ends and between the outer wall surfaces of the housings 21 and 221 as illustrated in FIG. 1.

In the communication device 11, the transmitting unit 22 performs a process of converting a transmission target signal into a signal of a millimeter wave band and outputting the signal of the millimeter wave band to the waveguide tube 23. In the communication device 12, the receiving unit 222 performs a process of receiving the signal of the millimeter wave band transmitted via the waveguide tube 223 and restoring the original transmission target signal. The transmitting unit 22 and the receiving unit 222 will be specifically described below.

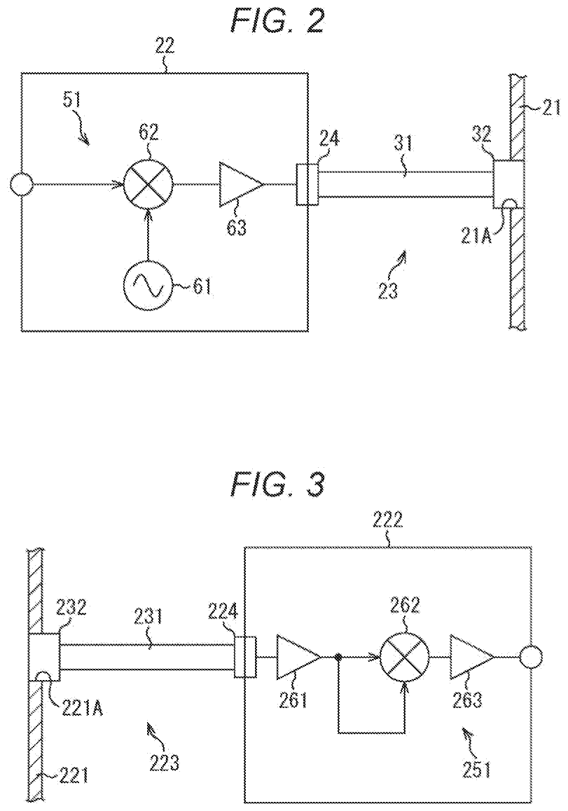

FIG. 2 illustrates an example of a specific configuration of the transmitting unit 22.

In the communication device 11, the transmitting unit 22 includes, for example, a signal generating unit 51 that processes the transmission target signal and generates the signal of the millimeter wave band. The signal generating unit 51 is a signal converting unit that converts the transmission target signal into the signal of the millimeter wave band, and includes, for example, an amplitude shift keying (ASK) modulation circuit. Specifically, the signal generating unit 51 generates an ASK modulated wave of a millimeter wave band by multiplying a signal of a millimeter wave band given from an oscillator 61 and the transmission target signal through a multiplier 62, amplifies the ASK modulated wave of the millimeter wave band through a power amplifier 63, and outputs a resulting signal. A connector device 24 is interposed between the transmitting unit 22 and the waveguide tube 23. The connector device 24 couples the transmitting unit 22 and the waveguide tube 23 by, for example, capacitive coupling, electromagnetic induction coupling, electromagnetic field coupling, resonator coupling, or the like.

FIG. 3 illustrates an example of a specific configuration of the receiving unit 222.

In the communication device 12, the receiving unit 222 includes, for example, a signal restoring unit 251 that processes the signal of the millimeter wave band given via the waveguide tube 223 and restores the original transmission target signal. The signal restoring unit 251 is a signal converting unit that converts the received signal of the millimeter wave band into the original transmission target signal, and includes, for example, a square detection circuit. Specifically, the signal restoring unit 251 converts the signal of the millimeter wave band (ASK modulated wave) given via a buffer 261 into the original transmission target signal by squaring the signal of the millimeter wave band through a multiplier 262, and outputs the original transmission target signal via a buffer 263. A connector device 224 is interposed between the waveguide tube 223 and the receiving unit 222. The connector device 224 couples the waveguide tube 223 and the receiving unit 222 by, for example, capacitive coupling, electromagnetic induction coupling, electromagnetic field coupling, resonator coupling, or the like.

As described above, in the communication system 10 according to the present embodiment, the communication device 11 and the communication device 12 perform communication using the signal of the millimeter wave band in a state in which the planes of the housing 21 and the housing 221 (housings) are brought into contact with or close to each other. More specifically, communication is performed in a state in which the opening ends of the coupling portion 32 of the two waveguide tubes 23 and the opening end of the coupling portion 232 of the waveguide tube 223 are brought into contact with or close to each other. Therefore, it is possible to suppress the leak of the electromagnetic waves to the outside of the waveguide tube 23 and the waveguide tube 223 as compared with the wireless communication using the slot antenna. As a result, it is possible to suppress the degradation in the transmission characteristic caused by the leak of the electromagnetic wave. Further, broadband transmission can be performed as compared with the wireless communication using the slot antenna.

In addition, since a form of communication is communication using the signal of the millimeter wave band as the radio frequency signal, so-called millimeter wave communication, the following advantages are obtained.

a) Since millimeter wave communication can have a wide communication band, it is possible to increase a data rate simply. b) A frequency used for transmission can be kept away from a frequency of other baseband signal processing, and interference between a millimeter wave and a frequency of a baseband signal hardly occurs.

c) Because the millimeter wave band has a short wavelength, a coupling structure and a waveguide structure decided in accordance with a wavelength can be reduced. In addition, since distance attenuation is large, and diffraction is also small, it is easy to perform electromagnetic shielding.

d) In normal wireless communication, there are strict regulations for stability of carrier waves in order to prevent interference or the like. In order to realize a carrier wave with high stability, an external frequency reference part with high stability, a multiplier circuit, a phase locked loop (PLL) circuit, and the like are used, and a circuit size increases. On the other hand, in the millimeter wave communication, it is possible to easily prevent the leak to the outside and use a carrier wave with low stability for transmission, and thus it is possible to suppress an increase in circuit size.

In particular, the millimeter wave communication is a communication system in which the transmission paths of the communication device 11 and the communication device 12 have waveguide structures using the waveguide tube 23 and the waveguide tube 223, and communication is performed in a state in which the communication device 11 and the communication device 12 are brought into contact with or close to each other, and thus it is possible to suppress input of an extra signal from the outside. Thus, a complicated circuit such as an arithmetic circuit or the like for removing the signal when an extra signal is input from the outside is unnecessary, and thus it is possible to reduce the sizes of the communication device 11 and the communication device 12 accordingly.

Next, configurations of the waveguide tube 23 on the communication device 11 side and the waveguide tube 223 on the communication device 12 side constituting a connector device according to the first embodiment of the present technology will be specifically described. The connector device according to this embodiment is constituted by a combination of the waveguide tube 23 and the waveguide tube 223.

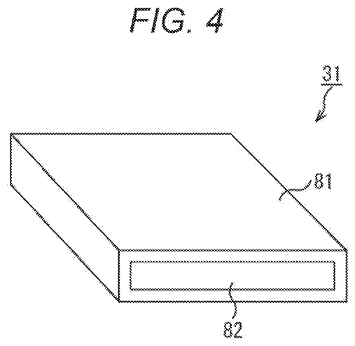

First, configurations of the transmission path portion 31 of the waveguide tube 23 on the communication device 11 side and the transmission path portion 231 of the waveguide tube 223 on the communication device 12 side will be described. Here, the configuration of the transmission path portion 31 of the waveguide tube 23 will be described as a representative example, but it is similar to the configuration of the transmission path portion 231 of the waveguide tube 223. FIG. 4 illustrates an example of the configuration of the transmission path portion 31 of the waveguide tube 23.

As illustrated in FIG. 4, the transmission path portion 31 of the waveguide tube 23 has, for example, a structure of a rectangular waveguide tube in which a tube 81 made from metal having a rectangular cross section is filled with a dielectric 82. Here, as an example, copper is used as a material of the tube 81 made from metal and liquid crystal polymer (LCP) is used as the dielectric 82. More specifically, the transmission path portion 31 according to the present example has, for example, a structure of a flexible waveguide tube cable in which an outer periphery of the liquid crystal polymer having a rectangular cross section with a width of 2.5 [mm} and a thickness of 0.2 [mm] is plated with, for example, copper.

Here, the dielectric waveguide tube formed by filling the inside of the tube 81 made from metal with the dielectric 82 has been exemplified as the transmission path portion 31, but the present technology is not limited thereto and may be a hollow waveguide tube. Further, the rectangular waveguide tube is preferably a rectangular waveguide tube in which a dimensional ratio of alongside and a short side of a cross section is 2:1. The rectangular waveguide tube of 2:1 has the advantage in that it is possible to prevent the occurrence of higher order modes and perform efficient transmission. Here, using a waveguide tube having a cross section shape other than a rectangle, for example, a waveguide tube having a square or circular cross section shape as the transmission path portion 31 is not excluded. Further, in the case of a waveguide tube having a small thickness, for example, in the case of a waveguide tube having a thickness of about 0.2 [mm], although transmission loss per unit length increases, the dimensional ratio of the long side and the short side may be 10:1 or 15:1 as well.

Since the liquid crystal polymer used as the dielectric 82 with which the tube 81 made from metal is filled has a material characteristic of a low specific dielectric constant (3.0) and a low dielectric loss tangent (0.002), there is an advantage in that the transmission loss of the transmission path portion 31 can be reduced. Generally, in a case where the dielectric loss tangent is small, the transmission loss is low. Further, since the liquid crystal polymer has low water absorbency, there is an advantage in that dimensional stability is good even under high humidity. Here, the liquid crystal polymer has been described as the dielectric 82, but the present technology is not limited thereto.

In addition to the liquid crystal polymer, polytetrafluoroethylene (PTFE), cyclo-olefin polymer (COP), or polyimide can be used as the dielectric 82 as well. In the material characteristic of PTFE, the specific dielectric constant is 2.0 and the dielectric loss tangent is 0.0002. In the material characteristic of COP, the specific dielectric constant is 2.3, and the dielectric loss tangent is 0.0002. In the material characteristic of polyimide, the specific dielectric constant is 3.5, and the dielectric loss tangent is 0.01.

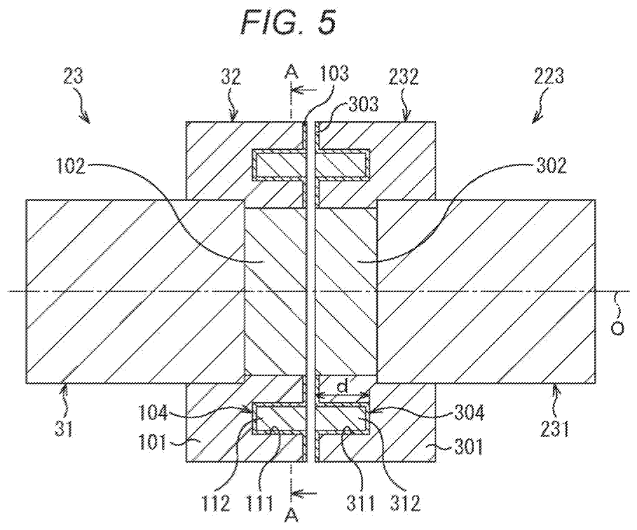

Next, a specific example of the coupling portion 32 of the waveguide tube 23 on the communication device 11 side and the coupling portion 232 of the waveguide tube 223 on the communication device 12 side will be described with reference to FIGS. 5 to 7.

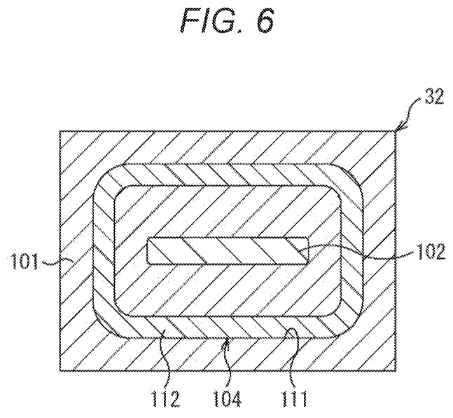

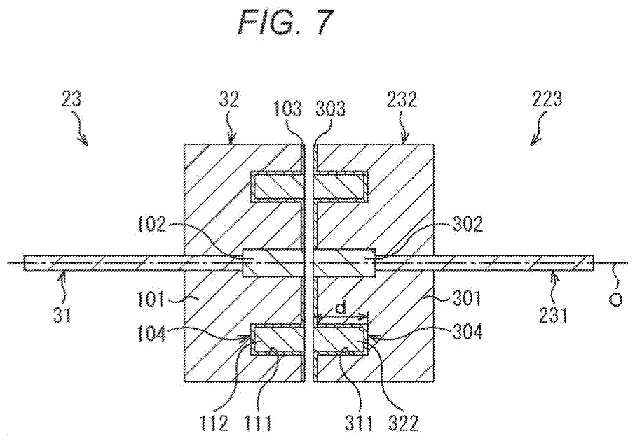

FIG. 5 is a plane cross-sectional view illustrating a configuration of each of the coupling portions 32 and 232 of the two waveguide tubes 23 and 223 of the connector device according to the first example. Further, FIG. 6 is an arrow cross-sectional view taken along line A-A of FIG. 5, and FIG. 7 is a side cross-sectional view illustrating each of the coupling portions 32 and 232 of the two waveguide tubes 23 and 223 of the connector device according to the first example.

In each of the coupling portions 32 and 232 of the two waveguide tubes 23 and 223, tubes 101 and 301 made from metal such as aluminum are filled with dielectrics 102 and 302, and opening end surfaces of the tubes 101 and 301 made from metal are covered with insulating layers 103 and 303. It should be noted that FIGS. 5 and 7 illustrate a configuration in which the tubes 101 and 301 are filled with the dielectrics 102 and 302 all over, but the entire insides of the tube 101 and the tube 301 need not be filled with the dielectrics 102 and 302, and it is desirable that the dielectrics 102 and 302 be formed in at least parts of the insides the tubes 101 and 301 made from metal, preferably, at least the opening end portions.

As the dielectrics 102 and 302 with which the tubes 101 and 301 made from metal are filled, the same material as the dielectric 82 of the transmission path portion 31, specifically, a liquid crystal polymer, PTFE, COP, or polyimide can be used. Further, in addition to these materials, polyether ether ketone (PEEK), polyphenylene sulfide (PPS), thermosetting resin, or ultraviolet curable resin can be used as the dielectrics 102 and 302. In the material characteristic of PEEK, the specific dielectric constant is 3.3, and the dielectric loss tangent is 0.003. In the material characteristic of PPS, the specific dielectric constant is 3.6, and the dielectric loss tangent is 0.001.

The insulating layers 103 and 303 covering the opening end surfaces of the tubes 101 and 301 made from metal include, for example, a coating of an insulating material. As the insulation coating, for example, an alumite processing process which is a plating process dedicated for aluminum is suitable. Aluminum conducts electricity, but an alumite film has an insulating property. It should be noted that, here, only the opening end surfaces of the tubes 101 and 301 made from metal are covered with the insulating layers 103 and 303 as illustrated in FIGS. 5 and 7, but the entire outer surfaces of the tubes 101 and 301 or exposed surfaces of the dielectrics 102 and 302 may be covered.

As described above, the connector device according to the present embodiment includes the two waveguide tubes 23 and 223 which include the transmission path portions 31 and 231, the coupling portions 32 and 232, respectively, and has a configuration in which coupling is performed in a state in which the opening ends of the coupling portions 32 and 232 are brought into contact with or close to each other. Therefore, it is possible to suppress the leak of the electromagnetic wave to the outside as compared with the wireless communication using the slot antenna. In particular, the coupling portions 32 and 232 have a configuration in which the tubes 101 and 301 made from metal are filled with the dielectrics 102 and 302, and the opening end surfaces of the tubes 101 and 301 made from metal are covered with the insulating layers 103 and 303. Accordingly, since the two waveguide tubes 23 and 223 have a structure in which no metal is exposed on the contact surface, there is an advantage in that it is possible to improve connection reliability, and it is easy to cope with waterproofing. In addition, in a connector device having a structure in which metals come into contact with each other, there are problems such as a contact failure caused by rust of the connector device, contact wear or a decrease in connection reliability caused by repeated attachment and detachment, and difficulty to cope with waterproofing.

The coupling portions 32 and 232 of the two waveguide tubes 23 and 223 have a configuration in which choke structures 104 and 304 are disposed around the opening ends of the tubes 101 and 301 made from metal. The choke structures 104 and 304 include grooves 111 and 311 formed in an annular shape (a rectangular annular shape in the present example) around a central axis O of the waveguide tubes 23 and 223, respectively. It is desirable to set a depth d of each of the grooves 111 and 311 of the choke structures 104 and 304 to ¼ of a wavelength λ of a radio frequency (the millimeter wave in the present example) transmitted through the waveguide tubes 23 and 223, that is, λ/4. Here, “λ/4” is the meaning in a case where it is substantially λ/4 in addition to a case where it is strictly λ/4, and the existence of various variations caused by a design or manufacturing is allowable.

In choke structures 104 and 304, in a case where the depth d of each of grooves 111 and 311 is λ/4, in the steady state, the incident wave and the reflected wave generated in grooves 111 and 311 are in opposite phases. Therefore, since an incident wave is canceled by a reflected wave generated in the grooves 111 and 311, it does not advance outside the choke structures 104 and 304. As a result, in the connector device in which the waveguide tubes 23 and 223 are coupled in a state in which the opening ends are brought into contact with or close to each other, it is possible to suppress the leak of the electromagnetic wave to the outside through the operations of the choke structures 104 and 304.

Here, the example in which the choke structures 104 and 304 have the configuration in which the number of stages of the grooves 111 and 311 is one is given, but the number of stages of the grooves 111 and 311 is not limited to one but may be two or more. The effect of suppressing the leak of the electromagnetic wave to the outside in the choke structures 104 and 304 increases as the number of stages of the grooves 111 and 311 increases.

The operation and effect described above, that is, the operation and effect when the depth d of each of the grooves 111 and 311 is λ/4 are obtained in a case where there is a space in each of each of the grooves 111 and 311 of the choke structures 104 and 304. On the other hand, the connector device according to the present example has a configuration in which, the inner walls of the grooves 111 and 311 are covered with the insulating layers 103 and 303 covering the opening end surfaces of the tubes 101 and 301 made from metal, and the insides thereof are filled with dielectrics 112 and 312.

As the dielectrics 112 and 312 of the choke structures 104 and 304, the same material as the dielectrics 102 and 302 with which the tubes 101 and 301 made from metal are filled, specifically, a liquid crystal polymer, PTFE, COP, polyimide, PEEK, PPS, thermosetting resin, or ultraviolet curable resin can be used. Further, in addition to these materials, plastic, engineering plastic, or super engineering plastic can be used as the dielectrics 112 and 312. Further, for example, a dielectric constant-variable material such as a nematic liquid crystal can be used as the dielectrics 112 and 312.

Here, if a wavelength of the millimeter wave in the air is indicated by λ0, a wavelength of the millimeter wave in a dielectric is indicated by λg, and a specific dielectric constant of a dielectric is indicated by εᵣ, the wavelength λ0 of the millimeter wave in the air and the wavelength λg of the millimeter wave in the dielectric are indicated by a relation of the following Formula (1).

λg=λ0/√εᵣ (1)

On the basis of Formula (1), the wavelength in a case where the grooves 111 and 311 are filled with the dielectric can be made shorter than that in a case where there is a space in the grooves 111 and 311 in the choke structures 104 and 304. Due to the effect of reducing the wavelength by dielectric filling, the depth d of each of the grooves 111 and 311 in the connector device according to the first example can be set to be smaller than a depth λ/4 in a case where they are not filled with the dielectric (d<λ/4). Accordingly, it is possible to reduce the sizes of the waveguide tubes 23 and 223 in a direction along the central axis O (see FIGS. 5 and 7).

As described above, in the connector device according to the first example, since the waveguide tubes 23 and 223 have the configuration in which the choke structures 104 and 304 are disposed around the opening ends, it is possible to reliably suppress the leak of the electromagnetic wave to the outside of the waveguide tubes 23 and 223 through the operations of the choke structures 104 and 304. Accordingly, it is possible to suppress the degradation in the transmission characteristic between the waveguide tubes 23 and 223 caused by the leak of the electromagnetic wave.

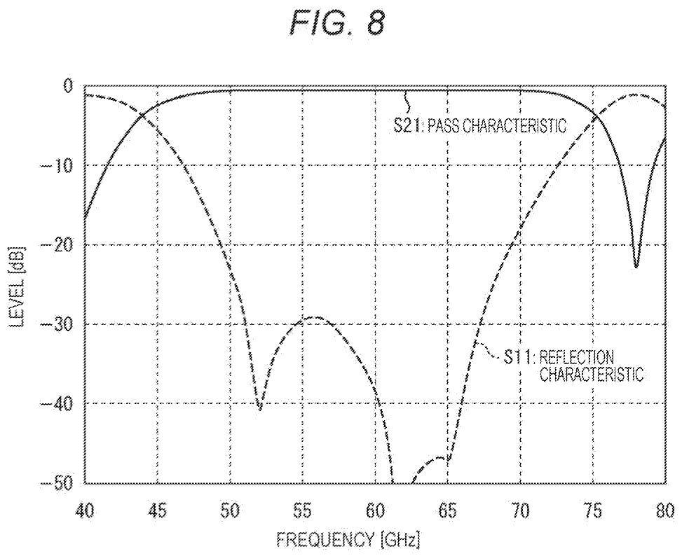

FIG. 8 illustrates a transmission characteristic between the two waveguide tubes 23 and 223 of the connector device according to the first example. In the case of the connector device according to the first example, for example, if attention is paid to a level of −10 [dB], a band of a reflection characteristic S11 increases up to about 47 to 73 [GHz] as is clear from the transmission characteristic of FIG. 8. Further, for a pass characteristic S21, a loss caused by reflection is suppressed, and the characteristic becomes flat as a whole. Accordingly, broadband transmission can be performed compared with the wireless communication using the slot antenna.

Further, in the connector device according to the first example, since the configuration in which the grooves 111 and 311 of the choke structures 104 and 304 are filled with the dielectrics 112 and 312 is employed, the depth d of each of the grooves 111 and 311 can be design to be smaller (d<λ/4) due to the effect of reducing the wavelength by filling of the dielectrics 112 and 312. Accordingly, since it is possible to reduce the sizes of the waveguide tubes 23 and 223 in the direction along the central axis O by a decrease in the depth d of each of the grooves 111 and 311, it is possible to reduce the size of the waveguide tubes 23 and 223, eventually, the connector device.

### Second Example

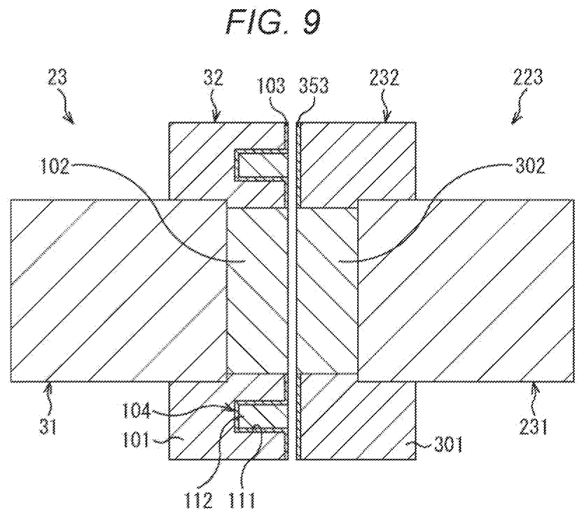

Next, a second example of the first embodiment of the present technology will be described with reference to FIG. 9.

The second example is a modified example of the first example. FIG. 9 is a plane cross-sectional view illustrating a configuration of each coupling portion of two waveguide tubes of a connector device according to the second example. In the connector device according to the first example, the configuration in which the choke structures 104 and 304 are disposed in both the coupling portion 32 of the waveguide tube 23 on the communication device 11 side and the coupling portion 232 of the waveguide tube 223 on the communication device 12 side is employed.

On the contrary, in the connector device according to the second example, the choke structure 104 is disposed only in the coupling portion 32 of the waveguide tube 23 on the communication device 11 side which is the transmitting side. In the case of this configuration, although the effect of suppressing the leak of the electromagnetic wave to the outside is lower than in the case where the choke structures 104 and 304 are disposed in both the transmitting side and the receiving side, it is possible to suppress the leak of the electromagnetic wave to the outside as compared with a case where the choke structure 104 is not disposed.

### Third Example

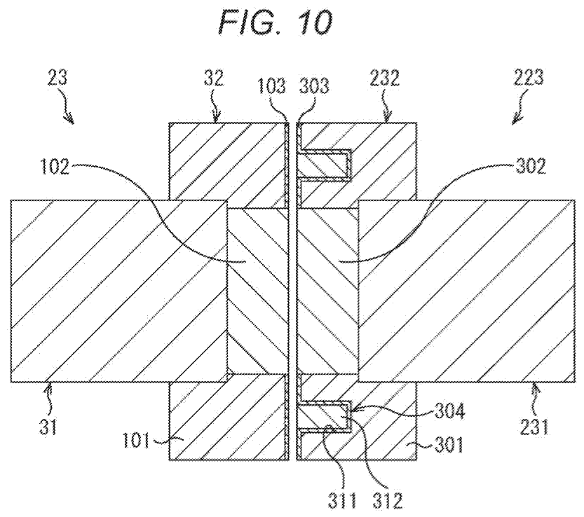

Next, a third example of the first embodiment of the present technology will be described with reference to FIG. 10.

The third example is a modified example of the first example. FIG. 10 is a plane cross-sectional view illustrating the configuration of each coupling portion of two waveguide tubes of a connector device according to third example. In the connector device according to the first example, a choke structures 104 and 304 are disposed in both the coupling portion 32 of the waveguide tube 23 on the communication device 11 side and the coupling portion 232 of the waveguide tube 223 on the communication device 12 side.

On the other hand, in the connector device according to the third example, the choke structure 304 is disposed only in the coupling portion 232 of the waveguide tube 223 on the communication device 12 side which is the receiving side. In the case of this configuration, although the effect of suppressing the leak of the electromagnetic wave to the outside is lower than in the case where the choke structures 104 and 304 are disposed in both the transmitting side and the receiving side, it is possible to suppress the leak of the electromagnetic wave to the outside as compared with a case where the choke structure 304 is not disposed.

### Fourth Example

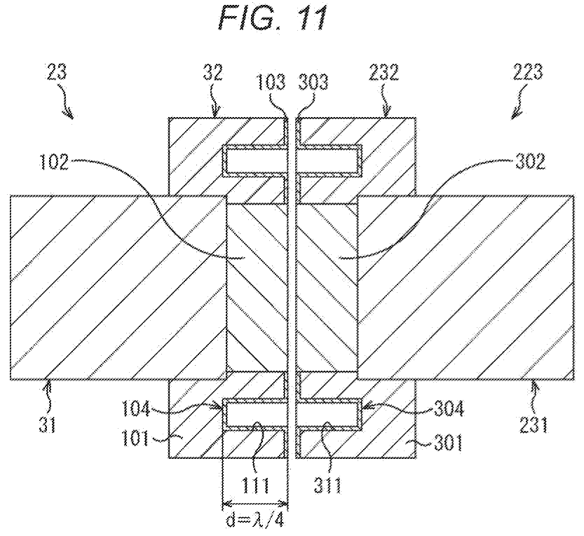

Next, a fourth example of the first embodiment of the present technology will be described with reference to FIG. 11.

The fourth example is a modified example of the first example. FIG. 11 is a plane cross-sectional view illustrating a configuration of each coupling portion of two waveguide tubes of a connector device according to the fourth example. In the connector device according to the first example, the configuration in which the grooves 111 and 311 of the choke structures 104 and 304 are filled with the dielectrics 112 and 312 is employed.

On the other hand, in the connector device according to the fourth example, the configuration in which the grooves 111 and 311 of the choke structures 104 and 304 are not filled with the dielectrics 112 and 312 is employed. In the case of this configuration, although the effect of reducing the wavelength by filling of the dielectrics 112 and 312 is unable to be obtained, it is possible to obtain the effect of suppressing the leak of the electromagnetic wave to the outside by the choke structures 104 and 304. In a case where the grooves 111 and 311 are not filled with the dielectrics 112 and 312, it is preferable to set the depth d of each of the grooves 111 and 311 to ¼ of the wavelength λ of the millimeter wave transmitted by the waveguide tubes 23 and 223, that is, λ/4. Accordingly, it is possible to suppress the leak of the electromagnetic wave to the outside through the operations of the choke structures 104 and 304.

Although the configuration in which none of the groove 111 of the choke structure 104 of the coupling portion 32 of the waveguide tube 23 on the transmitting side and the groove 311 of the choke structure 304 of the coupling portion 232 of the waveguide tube 223 on the receiving side are filled with the dielectric has been described herein, the present technology is not limited to this configuration. In other words, it is also possible to employ a configuration in which only one of the grooves 111 and 311 is not filled with a dielectric, that is, a configuration in which only one of the grooves 111 and 311 is filled with a dielectric.

### Fifth Example

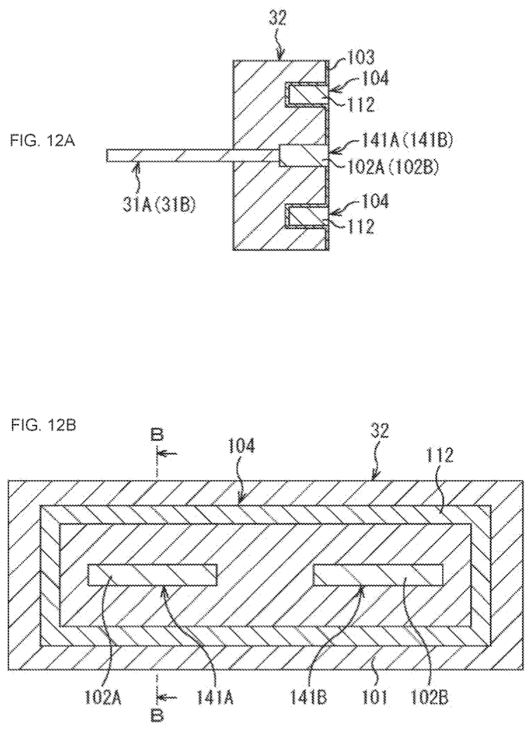

Next, a fifth example of the first embodiment of the present technology will be described with reference to FIG. 12.

In each of the above examples, the case where the present technology is applied to the communication system of one-way (one-direction) communication in which the radio frequency signal is transmitted from the communication device 11 to the communication device 12 has been described as an example, but the present technology can be applied to a communication system of two-way communication. A connector device according to the fifth example is a connector device applicable to the communication system of two-way communication.

A of FIG. 12 is a side cross-sectional view (an arrow cross-sectional view taken along line B-B in B of FIG. 12) of each coupling portion of two waveguide tubes of the connector device according to fifth example, and B of FIG. 12 is a longitudinal cross-sectional view (an arrow cross-sectional view taken along line A-A in FIG. 5) of each of the coupling portions of the two waveguide tubes.

In order to make two-way communication possible, at least one of the waveguide tube 23 on the communication device 11 side or the waveguide tube 223 on the communication device 12 side has the following configuration. Here, the description will proceed with the example of the waveguide tube 23. The waveguide tube 23 has a structure including a pair of transmission path portions 31A and 31B and a pair of waveguides 141A and 141B which form a coupling portion 32 by filling with dielectrics 102A and 102B. In forming this structure, it is desirable to form it integrally. The choke structure 104 is formed to surround each of a pair of waveguides 141A and 141B.

The connector device according to the fifth example has a configuration in which a pair of transmission path portions 31A and 31B and a pair of waveguides 141A and 141B are arranged side by side (arranged horizontally) in a width direction of the waveguides 141A and 141B. By forming a pair (two lanes) of structures including the transmission path portions 31A and 31B and the waveguides 141A and 141B as described above, it is possible to construct a communication system capable of performing two-way communication.

### Sixth Example

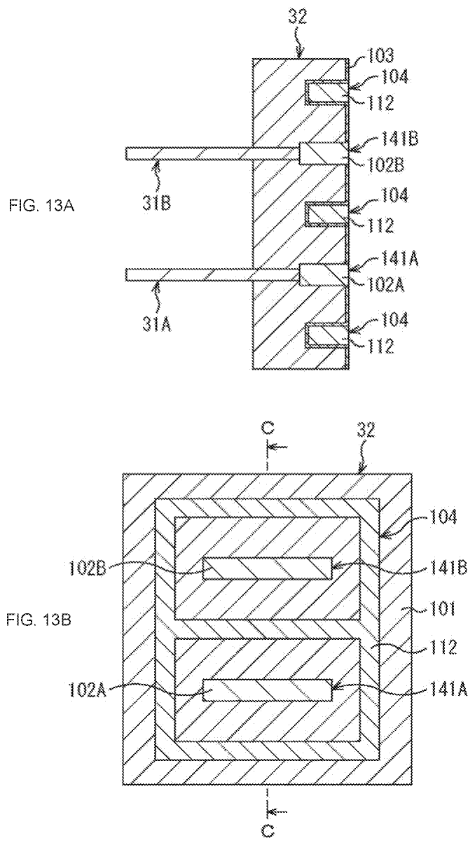

Next, a sixth example of the first embodiment of the present technology will be described with reference to FIG. 13.

The sixth example is a modified example of the fifth example. A of FIG. 13 is a side cross-sectional view (an arrow cross-sectional view taken along line C-C in B of FIG. 13) of each coupling portion of two waveguide tubes of the connector device according to fifth example, and B of FIG. 13 is a longitudinal cross-sectional view (an arrow cross-sectional view taken along line A-A in FIG. 5) of each of the coupling portions of the two waveguide tubes.

The connector device according to the fifth example has the configuration in which a pair of transmission path portions 31A and 31B and a pair of waveguides 141A and 141B which make two-way communication possible are arranged side by side in the width direction of the waveguides 141A and 141B. On the other hand, the connector device according to the sixth example has a configuration in which a pair of transmission path portions 31A and 31B and a pair of waveguides 141A and 141B are stacked vertically in a thickness direction of the waveguides 141A and 141B. In A of FIG. 13, a pair of transmission path portions 31A and 31B are separated from each other, but, for example, the transmission path portions 31A and 31B are integrated and introduced into the transmitting unit 11 (see FIG. 1).

As described above, even in the connector device according to the sixth example having the configuration in which a pair of transmission path portions 31A and 31B and a pair of waveguides 141A and 141B are stacked vertically, it is possible to construct a communication system capable of performing two-way communication, similarly to the connector device according to the fifth example.

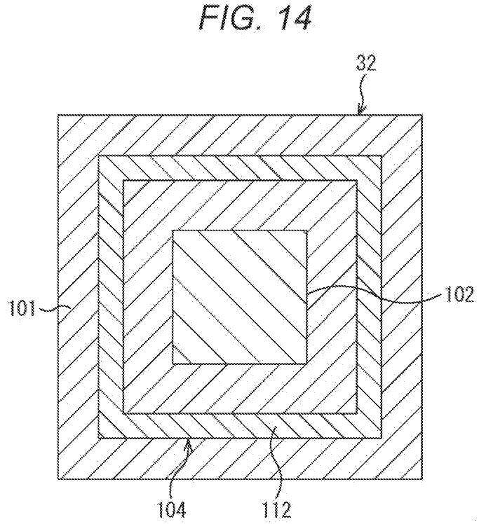

Even in examples other than the fifth example and the sixth example, when a waveguide tube having a square or circular cross section shape is employed as at least one of the two waveguide tubes 23 and 223, it is possible to construct a communication system capable of performing two-way communication. Specifically, when a waveguide tube having a square cross section shape illustrated in FIG. 14 is employed as at least one of the two waveguide tubes 23 and 223, it is possible to realize two-way communication using a horizontally polarized wave having a polarization plane which is horizontal to the ground or a vertically polarized wave (orthogonally polarized wave) having a polarization plane which is vertical to the ground. In a case where a waveguide tube having a circular cross section shape is used, it is possible to realize two-way communication using a right-handed circularly polarized wave rotating rightward in a traveling direction of an electromagnetic wave or a left-handed circularly polarized waves rotating leftward.

<Degradation in Transmission Characteristic Associated with Misalignment Between Two Coupling Portions or the Like>

In the connector device according to the examples described above, particularly, the connector device according to the first example, the case where the two coupling portions 32 and 232 are aligned with each other has been described, but the central axes O of both the coupling portions 32 and 232 are not necessarily aligned with each other due to an installation error or the like when the coupling portions 32 and 232 are installed. Further, in a case where there is a deviation between the central axis O of the coupling portion 32 and the central axis O of the coupling portion 232, the transmission characteristic is likely to degrade.

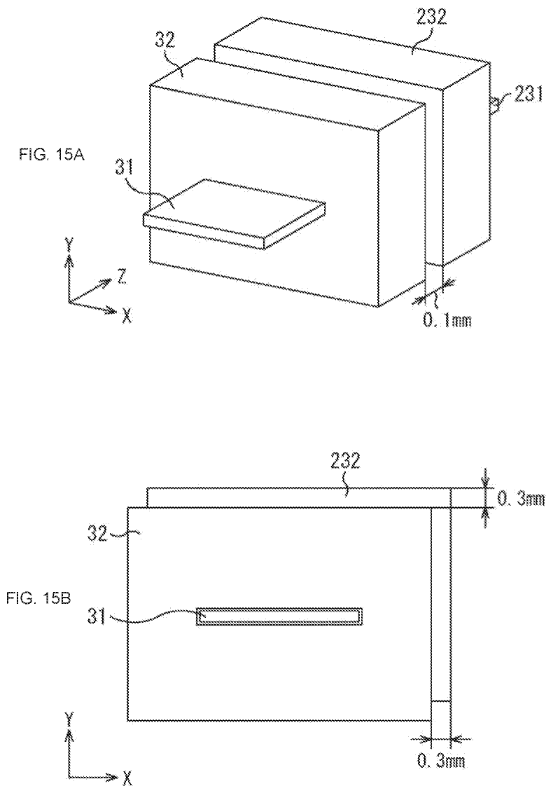

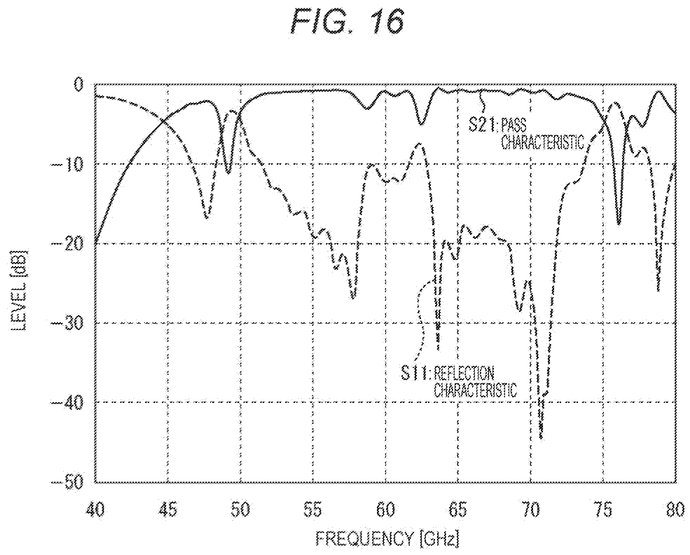

Here, for example, a transmission characteristic in a case where the central axis O of the coupling portion 232 deviates from the central axis O of the coupling portion 32 by 0.3 mm in an X direction and 0.3 mm in a Y direction, and there is a gap of 0.1 mm in a Z direction in the connector device according to the first example as illustrated in A and B of FIG. 15 is considered. A transmission characteristic between the two waveguide tubes 23 and 223 in this case is illustrated in FIG. 16.

As is apparent from the transmission characteristic illustrated in FIG. 16, in the case where there are a misalignment and a gap between the two coupling portions 32 and 232, a dip point occurs near a central portion (60 GHz) of a flat band (about 50 GHz to 70 GHz) of the pass characteristic S21 illustrated in FIG. 8, and the transmission characteristic degrades. This is considered to be caused due to the following reason. In other words, as the central axis O deviates, a large amount of electromagnetic waves radiated from the coupling portion 32 (coupling portion 232) introduces into the groove 311 (groove 211) of the choke structure 304 (choke structure 104) of the coupling portion 232 (coupling portion 32), it becomes an oscillation state at a frequency f1 caused by the wavelength circling the groove 311 (groove 211), and the dip point of the pass characteristic S21 is induced.

### Seventh Example

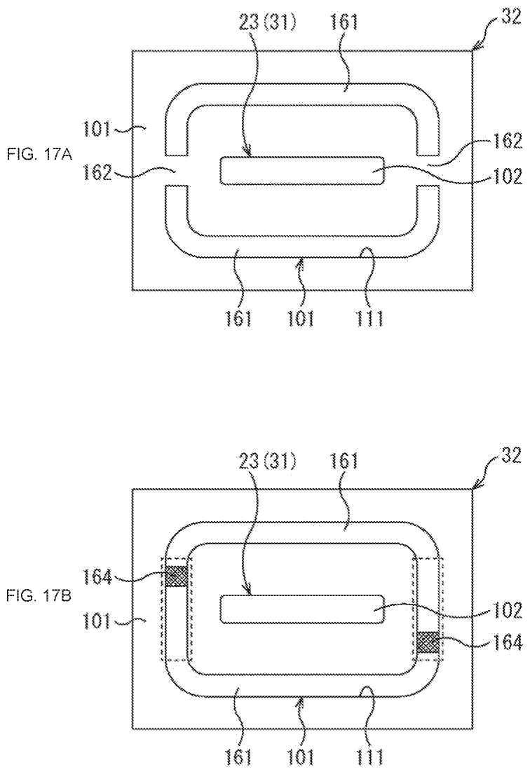

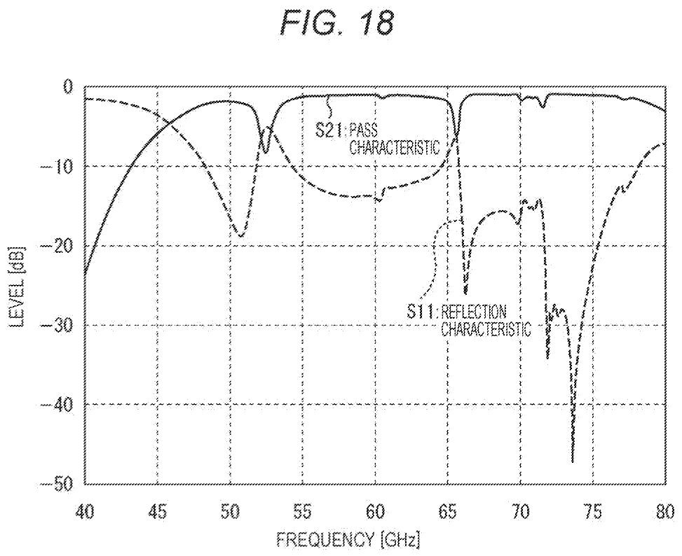

Next, a seventh example of the first embodiment of the present technology will be described with reference to FIGS. 17 and 18.

The seventh example is a modified example of the first example, specifically, a modified example of the choke structures 104 and 304 in the connector device according to the first example. Here, the choke structure 104 on the coupling portion 32 side will be described, but the same applies to the choke structure 304 on the coupling portion 232 side.

In the seventh example, a configuration in which some groove portions 162 differ in the depth of the groove 111 from the other groove portion 161 in the choke structure 104 on the coupling portion 32 side as illustrated in A of FIG. 17 so that an excellent transmission characteristic can be maintained even when there is a misalignment or the like between the two coupling portions 32 and 232 is employed. The depth of the groove 111 is a depth from the opening end surface of the coupling portion 32.

Specifically, some groove portions 162 are formed to have a depth different from the depth d of the other groove portions 161. In other words, some groove portions 162 may be shallow or deeper in the depth d than the other groove portions 161, and a depth range is “0 to (d+α).” The bottom surface of the other groove portions 161 is the bottom surface of the groove 111. In the example of A of FIG. 17 illustrating an example of the configuration of the choke structure 104, the depth of some groove portions 162 is 0, that is, the same as the opening end surface of the coupling portion 32.

In the example of A of FIG. 17, when the groove 111 is dug (formed) in the opening end surface of the coupling portion 32, parts thereof are not dug, so that some groove portions 162 are formed integrally with the coupling portion 32. In other words, some groove portions 162 include the same material as the coupling portion 32 and have conductivity. Accordingly, some groove portions 162 perform an operation of blocking the propagation of the electromagnetic wave which is radiated from the coupling portion 232 and enters the groove 111 of the choke structure 104.

Two or more groove portions 162 (two groove portions 162 in the present example) are formed on the short sides of the groove 111 formed in a rectangular annular shape, that is, in the left and right short sides in the drawing. The short side of the groove 111 is also the short side of the waveguide tube 23 (the transmission path portion 31). In a case where the radio frequency signal is transmitted through the waveguide tube 23, a transmission form in which an electric field is generated in a direction along the short side of the waveguide tube 23 is generally employed. Therefore, some groove portions 162 are disposed as the groove portion along the direction of the electric field generated when the waveguide tube 23 transmits the radio frequency signal, that is, the groove portion on the short side of the waveguide tube 23.

As described above, in the choke structure 104, some groove portions 162, for example, two groove portions 162, having a different depth from the other groove portions 161 are formed on the short side of the groove 111 having the rectangular annular shape, and thus it is possible to maintain the transmission characteristic excellently through the operation of some groove portions 162 even when there is a misalignment or the like between the two coupling portions 32 and 232. The operation of some groove portions 162 will be described below.

A transmission characteristic in the case of the choke structure 104 according to the seventh example when the central axis O of the coupling portion 232 deviates from the central axis O of the coupling portion 32 by 0.3 mm in an X direction and 0.3 mm in a Y direction, and there is a gap of 0.1 mm in a Z direction as illustrated in A and B of FIG. 15 is illustrated in FIG. 18. As is apparent from FIG. 18, according to the choke structure 104 of the seventh example, it is possible to cause the dip point of the pass characteristic S21 to be shifted to a frequency band far from the vicinity of the central portion (60 GHz) of the flat band.

This is caused due to the following reason. In other words, for example, when some groove portions 162, for example, two groove portions 162, different in depth from the other groove portions 161 are formed on the short side of the groove 111 having a rectangular annular shape, a length of the groove 111 in a circumference direction for the propagation of the electromagnetic wave which enters the groove 111 of the choke structure 104 becomes ½. Accordingly, since a resonance frequency caused by the choke structure 104 according to the seventh example is 2×f1 with respect to a resonance frequency f1 caused by the wavelength circling the groove 111, the dip point can be shifted to the frequency band higher than the central portion (60 GHz) of the transmission band.

In the example of A of FIG. 17, when the groove 111 is dug (formed) in the opening end surface of the coupling portion 32, parts thereof are not dug, so that some groove portions 162 are formed integrally with the coupling portion 32, but a method of forming some groove portions 162 is not limited thereto. For example, as illustrated in B of FIG. 17, after the groove 111 is formed on the opening end surface of the coupling portion 32, conductive members 164 may be buried in the groove 111 as some groove portions 162.

In this case, similarly to some groove portions 162, two or more conductive members 164 are disposed on the short side of the groove 111 having a rectangular annular shape, that is, the left and right short sides in the drawing. In forming the conductive members 164, the conductive members 164 need not be necessarily symmetrical bilaterally or rotationally. The effect of the choke structure 104, that is, the effect of suppressing the leak of the electromagnetic wave to the outside, is strong in a direction the electric field is cut off (a long side direction of the groove 111). However, if some conductive groove portions 162 are disposed on the long side of the groove 111, the effect thereof is remarkably lowered.

In a case where the conductive member 164 is disposed on the short side of the groove 111, it is difficult to prevent the effect of the choke structure 104. From this point of view, it is desirable to dispose the conductive member 164 on the short side of the groove 111. Here, since the effect of the choke structure 104 gradually decreases as the length of the conductive member 164 in the short-side direction is increased, it is desirable to suppress the length of the conductive member 164 in the short-side direction to fall within a region surrounded by a dotted line, that is, a linear region on the short side in B of FIG. 17. Further, the depth range within the groove 111 of the conductive member 164 is set to “0 to (d+α),” similarly to the case of some groove portions 162 in the example of A of FIG. 17.

For example, even in a case where two conductive members 164 are disposed on the short side of the groove 111 having a rectangular annular shape as described above, an operation and effect similar to those in the case of some groove portions 162 in the example of A of FIG. 17 can be obtained. In other words, even when there is a misalignment or the like between the two coupling portions 32 and 232, it is possible to maintain the transmission characteristic excellently by the operation of the conductive member 164 similar to some groove portions 162. Accordingly, since a certain degree of installation error or the like when the two coupling portions 32 and 232 are installed can be allowed, the degree of freedom of installation can be increased.

### Eighth Example

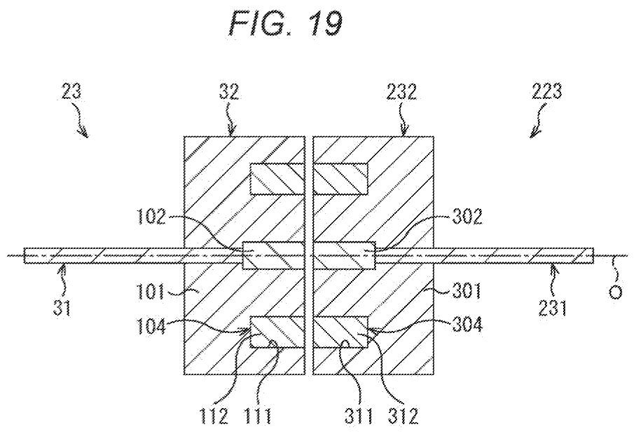

Next, an eighth example of the first embodiment of the present technology will be described with reference to FIG. 19.

In the connector device according to the first example, the configuration in which the opening end surfaces of the tubes 101 and 301 made from metal are covered with the insulating layers 103 and 303, but the opening end surfaces need not be necessarily covered with the insulating layers 103 and 303. In other words, the opening end surfaces of the tubes 101 and 301 made from metal may not be covered with the insulating layers 103 and 303 as illustrated in FIG. 19. In the case of this configuration, although the operation and effect of the insulating layers 103 and 303 are unable to be obtained, since the opening ends of the two coupling portions 32 and 232 are coupled in a state in which they are brought into contact with or close to each other, it is possible to obtain the effect of suppressing the leak of the electromagnetic wave to the outside.

### 3. Second Embodiment

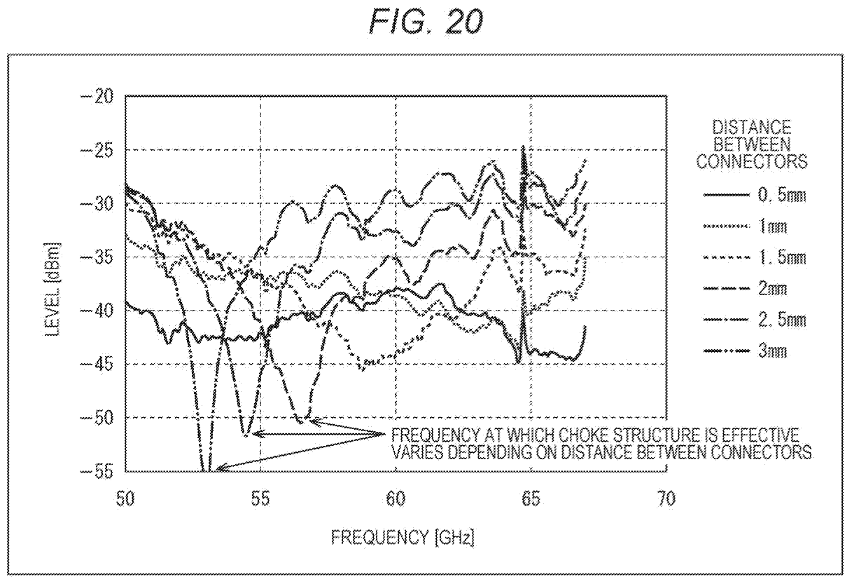

A second embodiment of the present technology will now be described with reference to FIGS. 20 to 33.

<Frequency Characteristic of Choke Structure with Respect to Distance Between Connectors>

A frequency characteristic of the choke structure 104 of the communication device 11 of FIG. 7 varies depending on a distance between the opening end of the coupling portion 32 of the waveguide tube 23 of the communication device 11 and the opening end of the coupling portion 232 of the waveguide tube 223 of the communication device 12 (hereinafter referred to as distance between connectors). Here, the frequency characteristic of the choke structure 104 indicates the distribution of a frequency component suppressed by the choke structure 104 among noises by unwanted radiation (hereinafter referred to as radiation noise) which is an electromagnetic wave (hereinafter referred to as a “leakage electromagnetic wave”) leaking from between the waveguide tube 23 of the communication device 11 and the waveguide tube 223 of the communication device 12 to the outside of the housing 21 of the communication device 11 and the housing 221 of the communication device 12.

FIG. 20 illustrates the frequency characteristic of the choke structure 104 in a case where the distance between the connectors is 0.5 mm, 1 mm, 1.5 mm, 2 mm, 2.5 mm, and 3 mm. A horizontal axis of a graph indicates a frequency (a unit is GHz) of the radiation noise, and a vertical axis indicates a level of the radiation noise (a unit is dBm).

As illustrated in this graph, the frequency of the radiation noise at which the choke structure 104 works effectively varies depending on the distance between the connectors. In other words, the frequency component of the radiation noise suppressed by the choke structure 104 varies depending on the distance between the connectors.

For example, in a case where the distance between the connectors is 2 mm, the radiation noise of a frequency around 56 GHz is minimized. In a case where the distance between the connectors is 2.5 mm, the radiation noise of a frequency around 54.5 GHz is minimized. In a case where the distance between the connectors is 3 mm, the radiation noise of a frequency around 53 GHz is minimized.

Therefore, the radiation noise can be reduced by adjusting a frequency (transmission frequency) of a signal to be transmitted to the frequency at which the choke structure 104 works effectively in accordance with the distance between the connectors.

### First Example

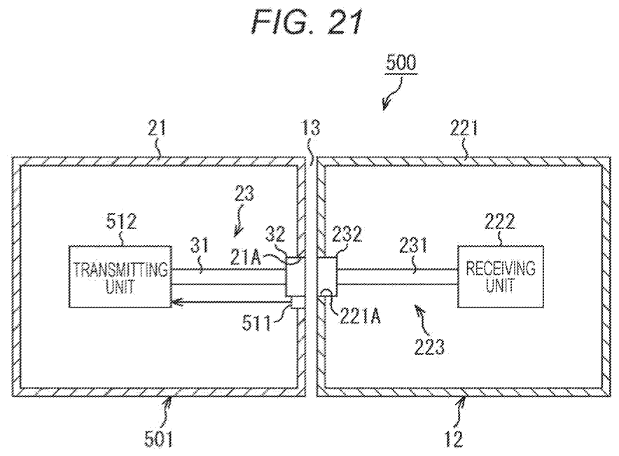

Next, a first example of the second embodiment of the present technology will be described with reference to FIGS. 21 to 29.

FIG. 21 is a plane view including a partial cross section illustrating an example of a configuration of a communication system according to the first example of the second embodiment of the present technology. Further, in FIG. 21, parts corresponding to those in FIG. 1 are denoted by the same reference numerals, and description thereof will be omitted as appropriate.

A communication system 500 of FIG. 21 differs from the communication system 10 of FIG. 1 in that a communication device 501 is disposed instead of the communication device 11. The communication device 501 differs from the communication device 11 in that a transmitting unit 512 is disposed instead of the transmitting unit 22, and a power sensor 511 is added.

The power sensor 511 is disposed to be close to the coupling portion 32 in the opening 21A of the housing 21. The power sensor 511 measures the level of the radiation noise leaking between the coupling portion 32 of the communication device 501 and the coupling portion 232 of the communication device 12 and supplies a measurement signal indicating the measurement result to the transmitting unit 512. Further, the power sensor 511 need not be necessarily brought into contact with the coupling portion 32, but it is desirable to place it at position which is as close to the coupling portion 32 as possible.

Similarly to the transmitting unit 22 of the communication device 11 of FIG. 1, the transmitting unit 512 performs a process of converting the transmission target signal into the signal of the millimeter wave band (hereinafter also referred to as a transmission signal) and outputs the signal of the millimeter wave band to the waveguide tube 23. Further, the transmitting unit 512 controls a relative relation between the transmission frequency of the transmission signal and the frequency characteristic of the choke structure 104 of the waveguide tube 23 such that the radiation noise is reduced. Specifically, as described later, the transmitting unit 512 adjusts the transmission frequency of the transmission signal on the basis of the measurement result of the power sensor 511 or the like so that the radiation noise is reduced.

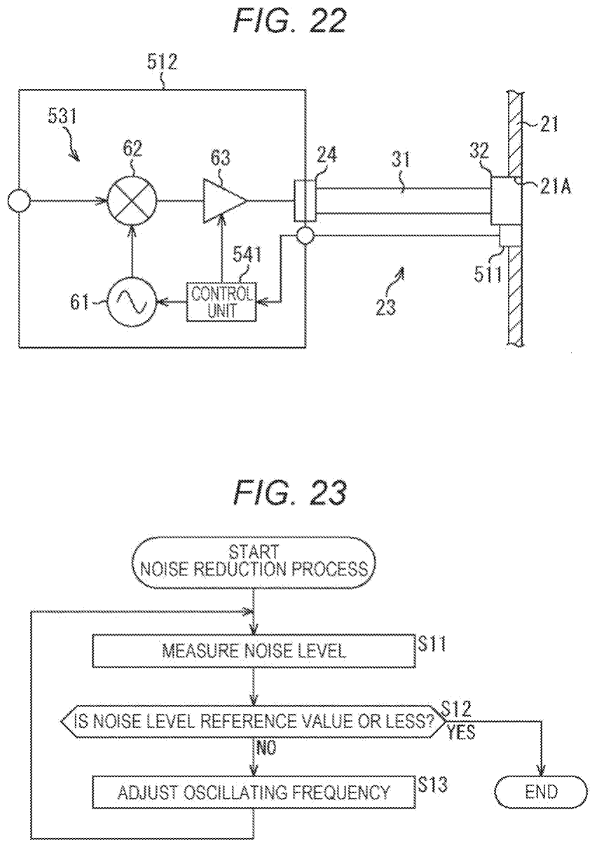

FIG. 22 illustrates an example of a specific configuration of the transmitting unit 512. Further, in FIG. 22, parts corresponding to those in FIG. 2 are denoted by the same reference numerals, and description thereof will be omitted as appropriate.

The transmitting unit 512 differs from the transmitting unit 22 of FIG. 2 in that a signal generating unit 531 is disposed instead of signal generating unit 51. The signal generating unit 531 differs from the signal generating unit 51 in that a control unit 541 is disposed.

The control unit 541 controls the relative relation between the transmission frequency of the transmission signal and the frequency characteristic of the choke structure 104 of the waveguide tube 23 such that the radiation noise is reduced. Specifically, as described later, the control unit 541 adjusts the transmission frequency of the transmission signal by adjusting an oscillating frequency of the oscillator 61 on the basis of the measurement result of the power sensor 511 or the like so that the radiation noise is reduced. Further, the control unit 541 adjusts a gain of the power amplifier 63 on the basis of the measurement result of the power sensor 511 or the like.

### First Example of Noise Reduction Process

Next, a first example of a noise reduction process executed by the communication device 501 will be described with reference to a flowchart of FIG. 23. This process is started, for example, when the transmission of the signal from the communication device 501 to the communication device 12 is started.

In step S11, the power sensor 511 measures the noise level. In other words, the power sensor 511 measures the level of radiation noise leaking between the coupling portion 32 of the communication device 501 and the coupling portion 232 of the communication device 12, and supplies a measurement signal indicating the measurement result to the control unit 541 of the transmitting unit 512.

In step S12, the control unit 541 determines whether or not the noise level is a reference value or less. Ina case where it is determined that the noise level exceeds the reference value, the process proceeds to step S13. For example, the reference value is set to a value which is equal to or less than a maximum allowable level of the radiation noise defined by laws, regulations, or the like.

In step S13, the control unit 541 adjusts the oscillating frequency. Specifically, the control unit 541 adjusts the transmission frequency of the transmission signal to be transmitted to the communication device 12 by adjusting the oscillating frequency of the oscillator 61 in a direction in which the noise level is decreased.

Thereafter, the process returns to step S11, and the process of step S11 to step S13 is repeatedly executed until it is determined in step S12 that the noise level is the reference value or less.

On the other hand, in a case where it is determined in step S12 that the noise level is the reference value or less, the noise reduction process ends.

The level of radiation noise can be suppressed to be the reference value or less by adjusting the transmission frequency of the transmission signal as described above. As described above, it is possible to prevent adverse influences on nearby electronic devices and the like and to stabilize the transmission characteristic.

Further, even when the distance between the connectors varies, and the frequency at which the choke structure 104 of the communication device 501 and the choke structure 304 of the communication device 12 work effectively varies, the level of radiation noise can be suppressed to be the reference value or less. Therefore, it is possible to increase the available distance between the connectors.

Further, since the radiation noise reduction effect is increased, for example, the choke structure can be simplified. For example, it is possible to delete one of the choke structure 104 of the communication device 501 and the choke structure 304 of the communication device 12 or reduce the number of multiplexings of the choke structure 104 or the choke structure 304.

Further, since the transmission frequency can be adjusted in accordance with performance or the like of the waveguide tube 23 and the choke structure 104 of the communication device 501 or the waveguide tube 223 and the choke structure 304 of the communication device 12, it is unnecessary to increase the processing accuracy, and it is possible to suppress a processing cost.

### Second Example of Noise Reduction Process

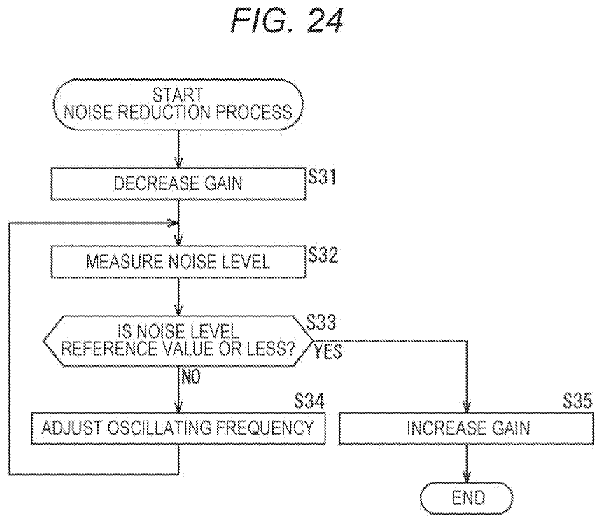

Next, a second example of the noise reduction process executed by the communication device 501 will be described with reference to a flowchart of FIG. 24. This process is started, for example, when the transmission of the signal from the communication device 501 to the communication device 12 is started.

In step S31, the control unit 541 decreases the gain of the power amplifier 63.

In step S32, the noise level is measured, similarly to the process in step S11 of FIG. 23.

In step S33, similarly to the process of step S12 of FIG. 23, it is determined whether or not the noise level is a reference value or less. In a case where it is determined that the noise level exceeds the reference value, the process proceeds to step S34.

In step S34, the oscillating frequency is adjusted, similarly to the process of step S13 of FIG. 23.

Thereafter, the process returns to step S32, and the process of step S32 to step S34 is repeatedly executed until it is determined in step S33 that the noise level is the reference value or less.

On the other hand, in a case where it is determined in step S33 that the noise level is the reference value or less, the process proceeds to step S35.

In step S35, the control unit 541 increases the gain of the power amplifier 63.

Thereafter, the noise reduction process ends.

As described above, the gain of the power amplifier 63 is decreased while the transmission frequency of the transmission signal is being adjusted. Accordingly, for example, the radiation noise increases until the adjustment of the transmission frequency is completed, thereby preventing the adverse effects on nearby electronic devices and the like.

### Third Example of Noise Reduction Process

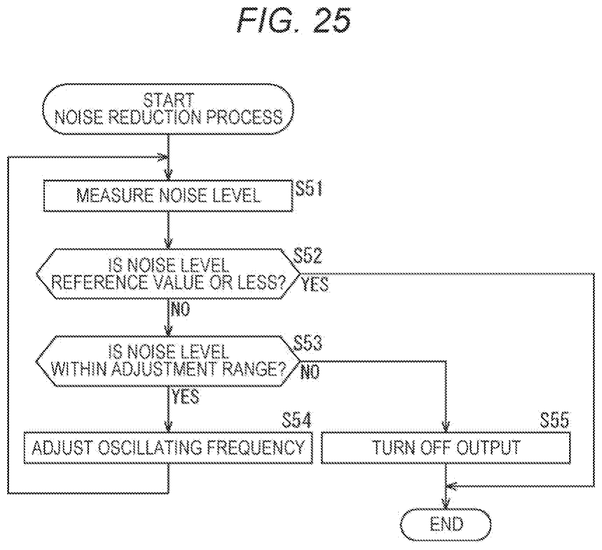

Next, a third example of the noise reduction process executed by the communication device 501 will be described with reference to a flowchart of FIG. 25. This process is started, for example, when the transmission of the signal from the communication device 501 to the communication device 12 is started.

In step S51, the noise level is measured, similarly to the process of step S11 of FIG. 23.

In step S52, similarly to the process of step S12 in FIG. 23, it is determined whether or not the noise level is a reference value or less. In a case where it is determined that the noise level exceeds the reference value, the process proceeds to step S53.

In step S53, the control unit 541 determines whether or not the noise level is within an adjustment range. In a case where the noise level does not exceed a predetermined allowable value, the control unit 541 determines that the noise level is within the adjustment range, and the process proceeds to step S54.

In step S54, the oscillating frequency is adjusted, similarly to the process of step S13 of FIG. 23.

Thereafter, the process returns to step S51, and the process of step S51 to step S54 is repeatedly executed until it is determined in step S52 that the noise level is the reference value or less or it is determined in step S53 that the noise level is within the adjustment range.

On the other hand, in a case where the noise level exceeds the predetermined allowable value in step S53, the control unit 541 determines that the noise level is out of the adjustment range, and the process proceeds to step S55. This is, for example, a case where the distance between the connectors between the communication device 201 and the communication device 12 is too far, and the noise level exceeds the predetermined allowable value.

In step S55, the control unit 541 turns off the output. For example, the control unit 541 sets the gain of the power amplifier 63 to 0, and stops the transmission of the signal from the communication device 501.

Thereafter, the noise reduction process ends.

On the other hand, in a case where it is determined in step S52 that the noise level is the reference value or less, the noise reduction process ends.

As described above, in a case where the noise level exceeds the predetermined allowable value, the transmission of the signal from the communication device 501 is stopped, and the adverse effects on the nearby electronic devices and the like are prevented.

### Fourth Example of Noise Reduction Process

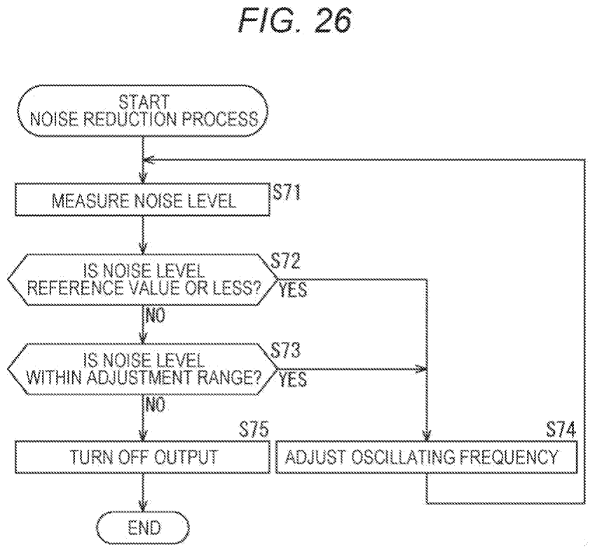

Next, a fourth example of the noise reduction process executed by the communication device 501 will be described with reference to a flowchart of FIG. 26. This process is started, for example, when the transmission of the signal from the communication device 501 to the communication device 12 is started.

In step S71, the noise level is measured, similarly to the process of step S11 of FIG. 23.

In step S72, similarly to the process of step S12 of FIG. 23, it is determined whether or not the noise level is a reference value or less. In a case where it is determined that the noise level exceeds the reference value, the process proceeds to step S73.

In step S73, similarly to the process of step S53 in FIG. 25, it is determined whether or not the noise level is within the adjustment range. In a case where it is determined that the noise level is within the adjustment range, the process proceeds to step S74.

In step S74, the oscillating frequency is adjusted, similarly to the process of step S13 of FIG. 23.

Thereafter, the process returns to step S71, and the process of step S71 to step S74 is repeatedly executed until it is determined in step S73 that the noise level is out of the adjustment range. Accordingly, for example, as the frequency characteristic of the choke structure varies or the noise level fluctuates depending on the distance between the connectors between the communication device 201 and the communication device 12, or the like, the transmission frequency is adjusted in real time so that the noise level becomes the reference value or less.

On the other hand, in a case where it is determined in step S73 that the noise level is out of the adjustment range, the process proceeds to step S75.

In step S75, the output is turned off, similarly to the process of step S55 of FIG. 25.

Thereafter, the noise reduction process ends.

### Fifth Example of Noise Reduction Process

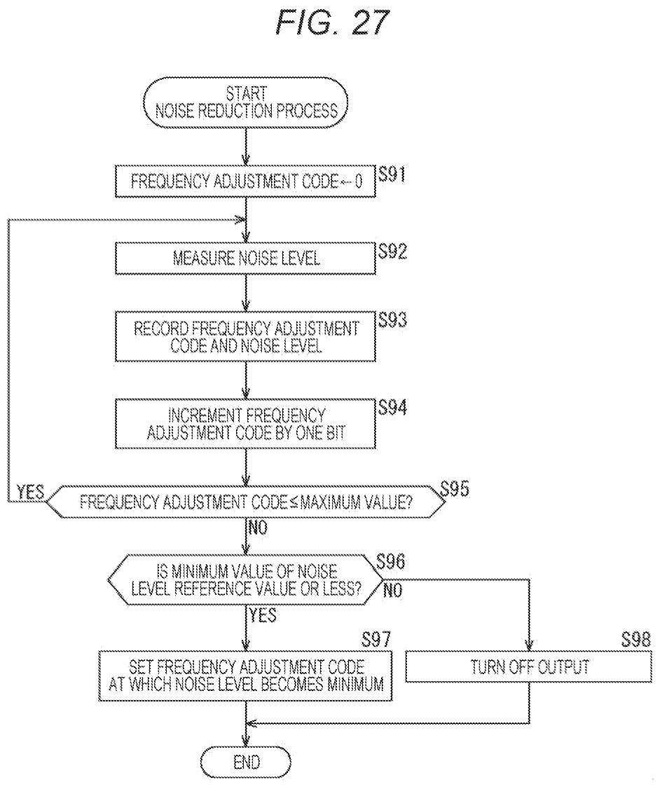

Next, a fifth example of the noise reduction process executed by the communication device 501 will be described with reference to a flowchart of FIG. 27. This process is started, for example, when the transmission of the signal from the communication device 501 to the communication device 12 is started.

In step S91, the control unit 541 sets a frequency adjustment code of the oscillator 61 to 0. The frequency adjustment code is a code for adjusting the oscillating frequency of the oscillator 61 and can be set in units of one bit. For example, if the frequency adjustment code is incremented by one bit, the oscillating frequency is increased by a predetermined value. Further, the oscillator 61 outputs a signal having an oscillating frequency corresponding to the frequency adjustment code.

In step S92, the noise level is measured, similarly to the process of step S11 in FIG. 23.

In step S93, the control unit 541 records the frequency adjustment code and the noise level measured by the power sensor 511.

In step S94, the control unit 541 increments the frequency adjustment code by one bit.

In step S95, the control unit 541 determines whether or not the frequency adjustment code is a maximum value or less. In a case where it is determined that the frequency adjustment code is the maximum value or less, the process returns to step S92.

Thereafter, the process of step S92 to step S95 is repeatedly executed until it is determined in step S95 that the frequency adjustment code exceeds the maximum value. Accordingly, the noise level is measured and recorded while changing the transmission frequency of the transmission signal at predetermined intervals.

On the other hand, in a case where it is determined in step S95 that the frequency adjustment code exceeds the maximum value, the process proceeds to step S96.

In step S96, the control unit 541 determines whether or not a minimum value of the noise level is a reference value or less. The control unit 541 detects the minimum value from the measurement value of the recorded noise level and compares the detected minimum value with the reference value. Further, in a case where the control unit 541 determines that the minimum value of the noise level is the reference value or less, the process proceeds to step S97.

In step S97, the control unit 541 sets the frequency adjustment code at which the noise level becomes minimum. In other words, the control unit 541 sets the frequency adjustment code of the oscillator 61 to the frequency adjustment code when the measurement value of the noise level becomes minimum. Accordingly, the transmission frequency of the transmission signal is set in the vicinity of the frequency at which the radiation noise reduction effect by the choke structure 104 is highest at the current distance between the connectors. Then, the radiation noise is suppressed to be as small as possible.

Thereafter, the noise reduction process ends.

On the other hand, in a case where it is determined in step S96 that the minimum value of the noise level exceeds the reference value, the process proceeds to step S98.

In step S98, the output is turned off, similarly to the process of step S55 in FIG. 25.

Thereafter, the noise reduction process ends.

### Sixth Example of Noise Reduction Process

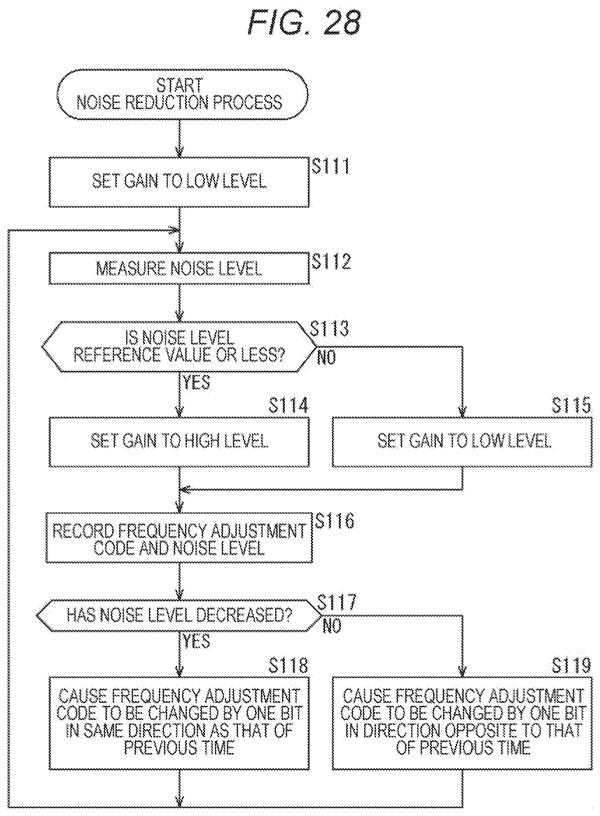

Next, a sixth example of the noise reduction process executed by the communication device 501 will be described with reference to a flowchart of FIG. 28. This process is started, for example, when the transmission of the signal from the communication device 501 to the communication device 12 is started.

In step S111, the control unit 541 sets the gain of the power amplifier 63 to a LOW level.

In step S112, the noise level is measured, similarly to the process of step S11 of FIG. 23.

In step S113, similarly to the process of step S12 of FIG. 23, it is determined whether or not the noise level is a reference value or less. In a case where it is determined that the noise level is the reference value or less, the process proceeds to step S114.

In step S114, the control unit 541 sets the gain of the power amplifier 63 to a HIGH level.

Thereafter, the process proceeds to step S116.

On the other hand, in a case where it is determined in step S113 that the noise level exceeds the reference value, the process proceeds to step S115.

In step S114, the control unit 541 sets the gain of the power amplifier 63 to the LOW level.

Thereafter, the process proceeds to step S116.

In step S116, the frequency adjustment code and the noise level are recorded, similarly to the process of step S93 in FIG. 27.

In step S117, the control unit 541 determines whether or not the noise level has decreased. Specifically, the control unit 541 compares the noise level recorded in the previous process of step S116 with the noise level recorded in the current process of step S116. Then, in a case where the current noise level is less than the previous noise level, the control unit 541 determines that the noise level has decreased, and the process proceeds to step S118.

In step S118, the control unit 541 causes the frequency adjustment code to be changed by one bit in the same direction as that of the previous time. Specifically, in a case where the frequency adjustment code is incremented by one bit in the previous process of step S118 or step S119, the control unit 541 also increments the frequency adjustment code by one bit this time. On the other hand, in a case where the frequency adjustment code is decremented by one bit in the previous process of step S118 or step S119, the control unit 541 also decrements the frequency adjustment code by one bit this time. In other words, the control unit 541 causes the frequency adjustment code to be changed in the same direction this time in response to the notification indicating that the noise level has decreased by the previous adjustment of the frequency adjustment code.

Thereafter, the process returns to step S112, and a process starting from step S112 is executed.

On the other hand, in step S117, the control unit 541 determines that the noise level has not decreased in a case where the present noise level is the previous noise level or more, and the process proceeds to step S119.

In step S119, the control unit 541 causes the frequency adjustment code to be changed by one bit in a direction opposite to that of the previous time. Specifically, in a case where the frequency adjustment code is incremented by one bit in the previous process of step S118 or step S119, the control unit 541 decrements the frequency adjustment code by one bit this time. On the other hand, in a case where the frequency adjustment code is decremented by one bit in the previous process of step S118 or step S119, the control unit 541 increments the frequency adjustment code by one bit this time. In other words, the control unit 541 causes the frequency adjustment code to be changed in the opposite direction this time in response to the notification indicating that the noise level has not decreased by the previous adjustment of the frequency adjustment code.

Thereafter, the process returns to step S112, and the process starting from step S112 is executed.

Accordingly, for example, as the frequency characteristic of the choke structure varies or the noise level fluctuates depending on the distance between the connectors between the communication device 201 and the communication device 12, or the like, the transmission frequency of the transmission signal is adjusted in real time, so that the radiation noise is suppressed. Further, the gain of the power amplifier 63 is adjusted so that the noise level becomes the reference value or less.

### Seventh Example of Noise Reduction Process

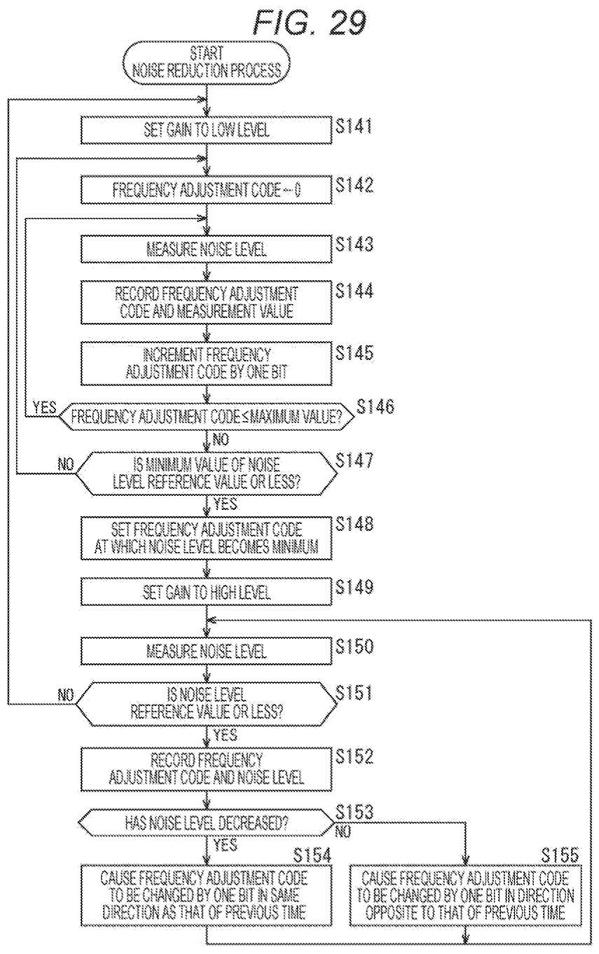

Next, a seventh example of the noise reduction process executed by the communication device 501 will be described with reference to a flowchart of FIG. 29. This process is started, for example, when the transmission of the signal from the communication device 501 to the communication device 12 is started.

In step S141, similarly to the process of step S111 of FIG. 28, the gain is set to the LOW level.

In steps S142 to S146, a process similar to steps S91 to S95 of FIG. 27 is executed.

In step S147, similarly to the process of step S96 of FIG. 27, it is determined whether or not the minimum value of the noise level is a reference value or less. In a case where it is determined that the minimum value of the noise level exceeds the reference value, the process returns to step S142.

Thereafter, a process of step S142 to step S147 is repeatedly executed until it is determined in step S147 that the minimum value of the noise level is the reference value or less.

On the other hand, in a case where it is determined in step S147 that the minimum value of the noise level is the reference value or less, the process proceeds to step S148.

In step S148, the frequency adjustment code of the oscillator 61 is set to the frequency adjustment code at which the noise level becomes minimum, similarly to the process of step S97 of FIG. 27.

In step S149, similarly to the process of step S114 of FIG. 28, the gain is set to the HIGH level.

In step S150, the noise level is measured, similarly to the process of step S11 in FIG. 23.

In step S151, similarly to the process of step S12 of FIG. 23, it is determined whether or not the noise level is a reference value or less. In a case where it is determined that the noise level exceeds the reference value, the process returns to step S141.

Thereafter, a process of step S141 to step S151 is repeatedly executed until it is determined in step S151 that the noise level is the reference value or less.

On the other hand, in a case where it is determined in step S151 that the noise level is the reference value or less, the process proceeds to step S152.

In step S152, the frequency adjustment code and the noise level are recorded, similarly to the process of step S93 of FIG. 27.

In step S153, similarly to the process of step S117 of FIG. 28, it is determined whether or not the noise level has decreased. In a case where it is determined that the noise level has decreased, the process proceeds to step S154.

In step S154, the frequency adjustment code is changed by one bit in the same direction as that of the previous time, similarly to the process of step S118 of FIG. 28.

Thereafter, the process returns to step S150, and a process starting from step S150 is executed.

On the other hand, in a case where it is determined in step S153 that the noise level has not decreased, the process proceeds to step S155.

In step S155, the frequency adjustment code is changed by one bit in a direction opposite to that of the previous time, similarly to the process of step S119 of FIG. 28.

Thereafter, the process returns to step S150, and the processes starting from step S150 are executed.

The seventh example of this noise reduction process is a combination of the fifth example of the noise reduction process of FIG. 26 and the sixth example of the noise reduction process of FIG. 27. Therefore, the radiation noise can be appropriately suppressed more quickly.

### Second Example

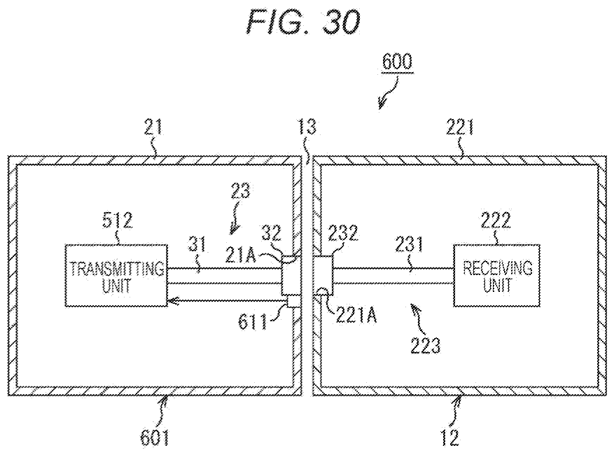

Next, a second example of the second embodiment of the present technology will be described with reference to FIGS. 30 to 32.

FIG. 30 is a plane view including a partial cross section illustrating an example of a configuration of a communication system according to the second example of the second embodiment of the present technology. Further, in FIG. 30, parts corresponding to those in FIG. 21 are denoted by the same reference numerals, and description thereof will be omitted as appropriate.

A communication system 600 of FIG. 30 differs from the communication system 500 of FIG. 21 in that a communication device 601 is disposed instead of the communication device 501. The communication device 601 differs from the communication device 501 in that a distance sensor 611 is disposed instead of the power sensor 511.

The distance sensor 611 is disposed to be close to the coupling portion 32 in the opening 21A of the housing 21. The distance sensor 611 measures the distance between the connectors between the communication device 11 and the communication device 12 and supplies a measurement signal indicating the measurement result to the transmitting unit 512. Further, although the distance sensor 611 need not be necessarily brought into contact with the coupling portion 32, it is desirable to place it at position which is as close to the coupling portion 32 as possible.

The transmitting unit 512 adjusts the transmission frequency of the transmission signal on the basis of the measurement result of the distance sensor 611 so that the radiation noise is reduced as described later.

### First Example of Noise Reduction Process

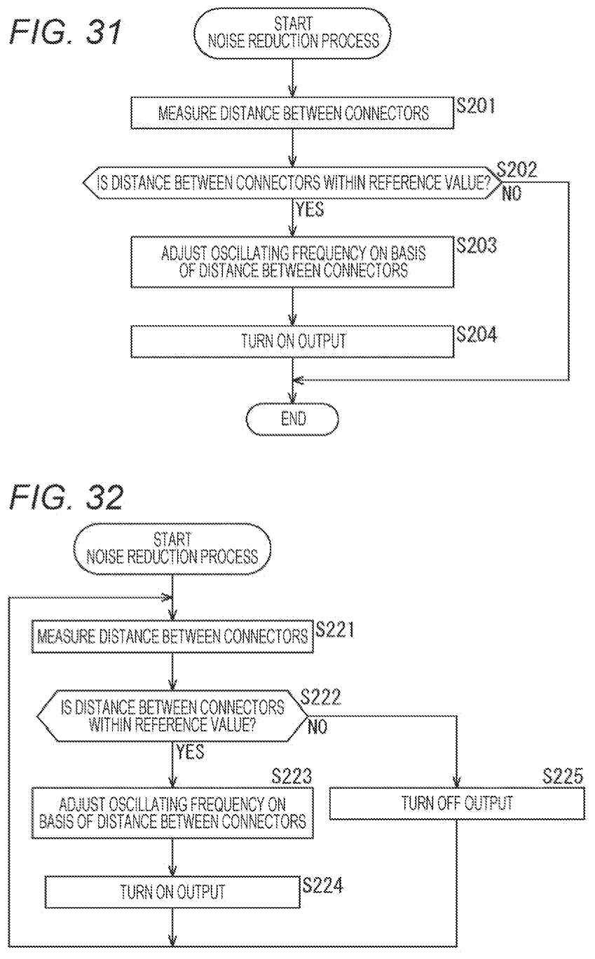

Next, a first example of a noise reduction process executed by the communication device 601 will be described with reference to a flowchart of FIG. 31. This process is started, for example, when the transmission of the signal from the communication device 601 to the communication device 12 is started. Further, before this process, for example, an output state of the communication device 601 is set to OFF.

In step S201, the distance sensor 611 measures the distance between the connectors. The distance sensor 611 supplies the measurement signal indicating the measurement result to the control unit 541 of the transmitting unit 512.

In step S202, the control unit 541 determines whether or not the distance between the connectors is within a reference value or not. In a case where it is determined that the distance between the connectors is within the reference value, the process proceeds to step S203.

Further, for example, the reference value is set to a connector distance at which the minimum value of the radiation noise for the transmission frequency is equal to or less than a maximum allowable level of the radiation noise defined by laws, regulations, or the like within a predetermined range.

In step S203, the control unit 541 adjusts the oscillating frequency on the basis of the distance between the connectors. For example, the control unit 541 holds data indicating the frequency at which the radiation noise becomes minimum in each distance between the connectors. Then, on the basis of the data, the control unit 541 detects the frequency at which the radiation noise becomes minimum at the current distance between the connectors, and adjusts the oscillating frequency of the oscillator 61 to the detected frequency.

In step S204, the control unit 541 turns on the output. For example, the control unit 541 sets the gain of the power amplifier 63 from 0 to a predetermined value. Accordingly, the transmission of the transmission signal from the communication device 601 is started.

Thereafter, the noise reduction process ends.

On the other hand, in a case where it is determined in step S202 that the distance between the connectors exceeds the reference value, the process of step S203 and step S204 is skipped, and the noise reduction process ends. In other words, in a case where the distance between the connectors exceeds the reference value, the output of the communication device 601 remains in the OFF state.

The effect similar to that of the noise reduction process of FIG. 23 can be obtained by using the distance sensor 611 instead of the power sensor 511 as described above. Further, in a case where the distance between the connectors exceeds the reference value, the transmission of the signal from the communication device 501 is stopped, and the occurrence of a high-level radiation noise is prevented.

### Second Example of Noise Reduction Process

Next, a second example of the noise reduction process executed by the communication device 601 will be described with reference to a flowchart of FIG. 32. This process is started, for example, when the transmission of the signal from the communication device 601 to the communication device 12 is started. Further, before this process, for example, the gain of the power amplifier 63 is set to 0, and the output of the communication device 601 is set to an OFF state.

In step S221, the distance between the connectors is measured, similarly to the process of step S201 of FIG. 31.

In step S222, similarly to the process of step S202 in FIG. 31, it is determined whether or not the distance between the connectors is within a reference value or not. In a case where it is determined that the distance between the connectors is within the reference value, the process proceeds to step S223.

In step S223, the oscillating frequency is adjusted on the basis of the distance between the connectors, similarly to the process of step S203 of FIG. 31.

In step S224, the output is turned on, similarly to the process of step S204 of FIG. 31. Further, in a case where the output is already turned on, the state is maintained.

Thereafter, the process returns to step S221, and the process starting from step S221 is executed.

On the other hand, in a case where it is determined in step S222 that the distance between the connectors exceeds the reference value, the process proceeds to step S225.

In step S225, the output is turned off, similarly to the process of step S55 of FIG. 25.

Thereafter, the process returns to step S221, and the process starting from step S221 is executed.

As described above, the transmission frequency of the transmission signal is adjusted in real time so that the radiation noise is suppressed in accordance with the change in the distance between the connectors. Further, in a case where the connector distance exceeds the reference value, the transmission of the signal is stopped, and the occurrence of the high-level radiation noise is prevented.

### Third Example

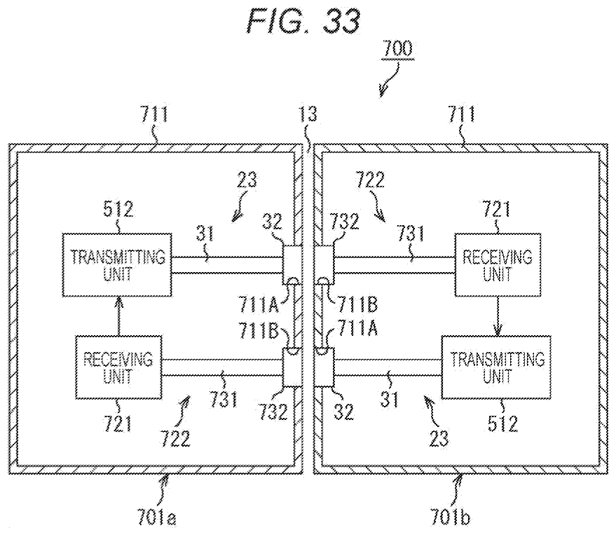

Next, a third example of the second embodiment of the present technology will be described with reference to FIG. 33.

FIG. 33 is a plane view including a partial cross section illustrating an example of a configuration of a communication system according to a third example of the second embodiment of the present technology. Further, in FIG. 33, parts corresponding to those in FIG. 21 are denoted by the same reference numerals, and description thereof will be omitted as appropriate.

A communication system 700 of FIG. 33 differs from the communication system 500 of FIG. 21 in that a communication device 701a and a communication device 701b are disposed instead of the communication device 501 and the communication device 12. The communication device 701a differs from the communication device 501 in that a housing 711 is disposed instead of the housing 21, a receiving unit 721 and a waveguide tube 722 are added, and the power sensor 511 is deleted. The communication device 701b has the same configuration as the communication device 701a.

The receiving unit 721 has substantially the same configuration as the receiving unit 222 of the communication device 12 of FIG. 1. However, the receiving unit 721 measures a level of a signal input via the waveguide tube 722, and supplies a measurement signal indicating the measurement result to the transmitting unit 512. Accordingly, the receiving unit 721 can measure the level of the radiation noise input via the waveguide tube 722 instead of the power sensor 511 of the communication device 501 of FIG. 21, and supply a measurement signal indicating the measurement result to the transmitting unit 512.

The waveguide tube 722 includes a transmission path portion 731 and a coupling portion 732. The transmission path portion 731 and the coupling portion 732 have configurations similar to those of the transmission path portion 231 and the coupling portion 232 of the waveguide tube 223 of the communication device 12 of FIG. 1.

The communication device 701a and the communication device 701b can perform two-way communication. Further, the communication device 701a and the communication device 701b can use the receiving unit 721 instead of the power sensor 511 of the communication device 501 of FIG. 21. Therefore, similarly to the communication device 501, the communication device 701a and the communication device 701b can adjust the transmission frequency of the transmission signal on the basis of the level of radiation noise and suppress the radiation noise.

### 4. Third Embodiment

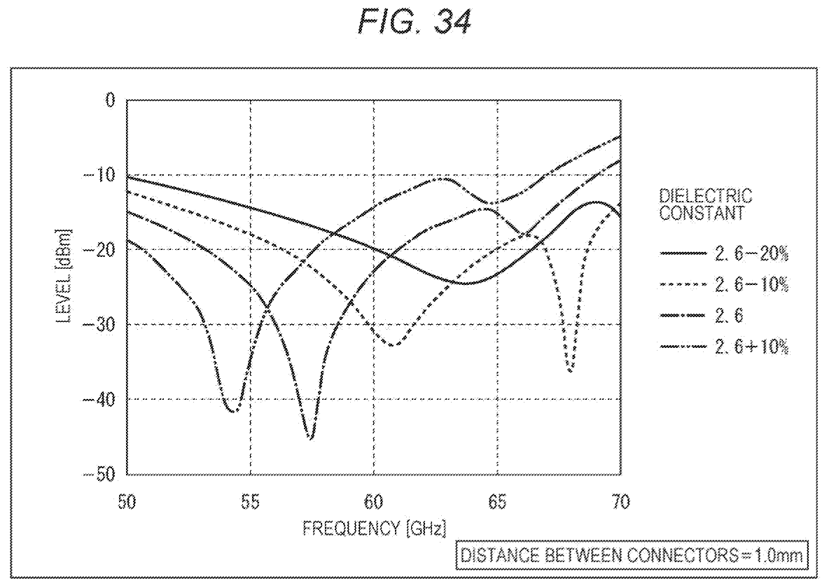

A third embodiment of the present technology will now be described with reference to FIGS. 34 to 48.

<Frequency Characteristic of Choke Structure with Respect to Dielectric Constant of Dielectric>

A frequency characteristic of the choke structure 104 of the communication device 11 in FIG. 7 varies depending on the dielectric constant of the dielectric 112 of the choke structure 104.

FIGS. 34 to 36 are graphs illustrating examples of a result of simulating the frequency characteristic of the choke structure 104 in a case where the dielectric constant of the dielectric 112 is 2.08 (2.6−20%), 2.34 (2.6−10%), 2.6, and 2.86 (2.6+10%). A horizontal axis of the graph indicates the frequency (a unit is GHz) of the radiation noise, and a vertical axis indicates the level of the radiation noise (a unit is dBm).

Further, as a condition of performing a simulation, a width of the coupling portion 32 of FIG. 6 is set to 7.4 mm, a height of the coupling portion 32 is set to 6.3 mm, a width of a frame of the dielectric 112 is set to 1 mm, and a depth of the dielectric 112 in a depth direction is set to 0.87 mm. Further, it is not filled with the dielectric 102 but hollow, and a hollow portion thereof has a width of 3.76 mm and a height of 1.88 mm.

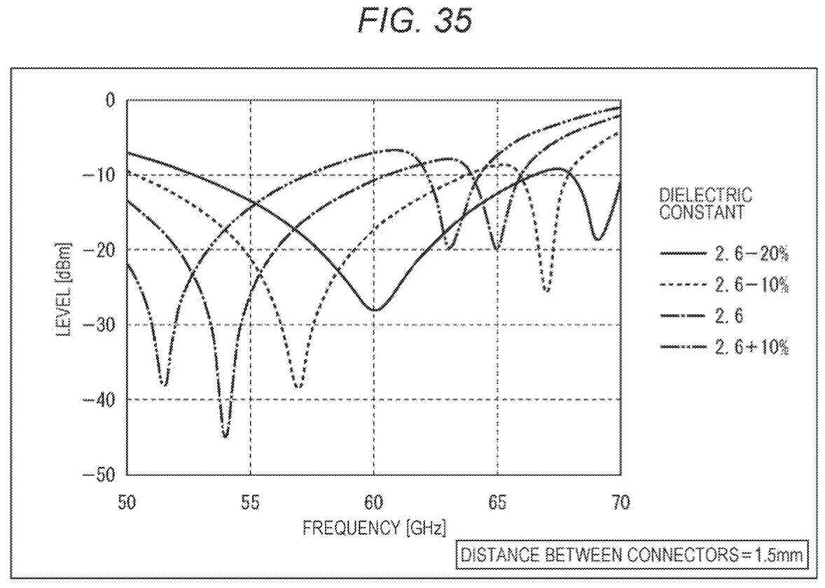

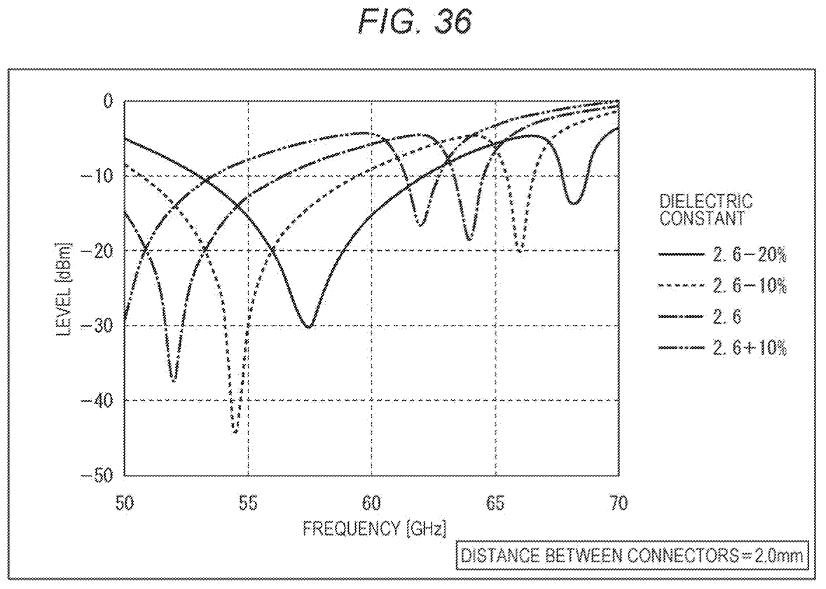

Further, FIG. 34 illustrates the frequency characteristic of the choke structure 104 in a case where the distance between the connectors is 1.0 mm, FIG. 35 illustrates the frequency characteristic of the choke structure 104 in a case where the distance between the connectors is 1.5 mm, and FIG. 36 illustrates the frequency characteristic of the choke structure 104 in a case where the distance between the connectors is 2.0 mm.

As illustrated in this example, the frequency of the radiation noise at which the choke structure 104 effectively works varies depending on the dielectric constant of the dielectric 112 in addition to the distance between the connectors. In other words, the frequency component of the radiation noise suppressed by the choke structure 104 varies depending on the distance between the connectors and the dielectric constant of the dielectric 112.

For example, it is possible to minimize the component around the frequency of the radiation noise of 57 GHz by setting the dielectric constant of the dielectric 112 to 2.6 when the distance between the connectors is 1.0 mm, setting the dielectric constant of the dielectric 112 to 2.34 when the distance between the connectors is 1.5 mm, and setting the dielectric constant of the dielectric 112 to 2.08 when the distance between the connectors is 2.0 mm.

### First Example

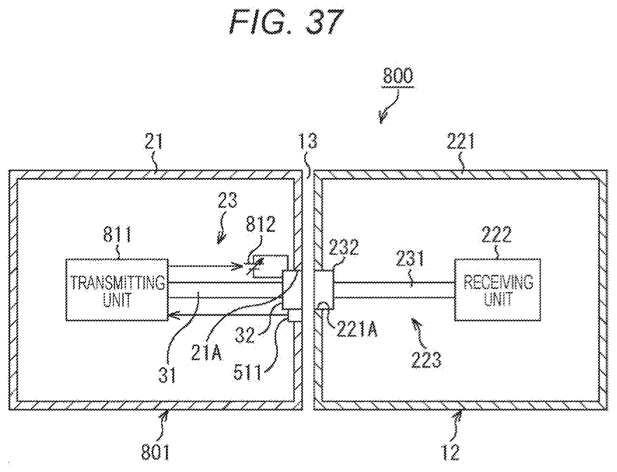

Next, a first example of the third embodiment of the present technology will be described with reference to FIGS. 37 to 44.

FIG. 37 is a plane view including a partial cross section illustrating an example of a configuration of a communication system according to the first example of the third embodiment of the present technology. Further, in FIG. 37, parts corresponding to those in FIG. 21 are denoted by the same reference numerals, and description thereof will be omitted as appropriate.

A communication system 800 of FIG. 37 differs from the communication system 500 of FIG. 21 in that a communication device 801 is disposed instead of the communication device 501. The communication device 801 differs from the communication device 501 in that a transmitting unit 811 is disposed instead of the transmitting unit 512, and a variable power source 812 is disposed.

The transmitting unit 811 performs a process of converting a transmission target signal into the signal of the millimeter wave band and outputting the signal of the millimeter wave band to the waveguide tube 23, similarly to the transmitting unit 22 of the communication device 11 of FIG. 1. Further, the transmitting unit 512 controls the relative relation between the transmission frequency of the transmission signal and the frequency characteristic of the choke structure 104 of the waveguide tube 23 such that the radiation noise is reduced. Specifically, as described later, the transmitting unit 512 adjusts the frequency characteristic of the choke structure 104 so that the radiation noise is reduced by adjusting the voltage of the variable power source 812 on the basis of the measurement result of the power sensor 511 or the like and adjusting the dielectric constant of the dielectric 112 of the choke structure 104 of the coupling portion 32.

The variable power source 812 adjusts the dielectric constant of the dielectric 112 by adjusting a bias voltage applied to the dielectric 112 of the choke structure 104 of the coupling portion 32 under the control of the transmitting unit 811. Therefore, in the communication device 501, the dielectric 112 includes a dielectric constant-variable material such as a nematic liquid crystal.

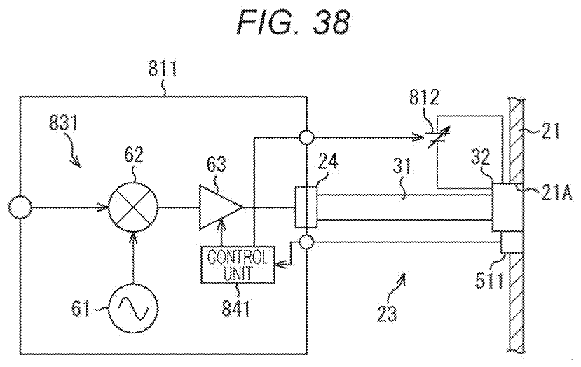

FIG. 38 illustrates an example of a specific configuration of the transmitting unit 811. Further, in FIG. 38, parts corresponding to those in FIG. 2 are denoted by the same reference numerals, and description thereof will be omitted as appropriate.

A transmitting unit 811 differs from transmitting unit 22 in FIG. 2 in that a signal generating unit 831 is disposed instead of signal generating unit 51. The signal generating unit 831 differs from the signal generating unit 51 in that a control unit 841 is disposed.

The control unit 841 controls the relative relation between the transmission frequency of the transmission signal and the frequency characteristic of the choke structure 104 of the waveguide tube 23 such that the radiation noise is reduced. Specifically, as described later, the control unit 841 adjusts the frequency characteristic of the choke structure 104 so that the radiation noise is reduced by adjusting the voltage of the variable power source 812 on the basis of the measurement result of the power sensor 511 and adjusting the dielectric constant of the dielectric 112 of the choke structure 104. Further, the control unit 841 adjusts the gain of the power amplifier 63 on the basis of the measurement result of the power sensor 511 or the like.

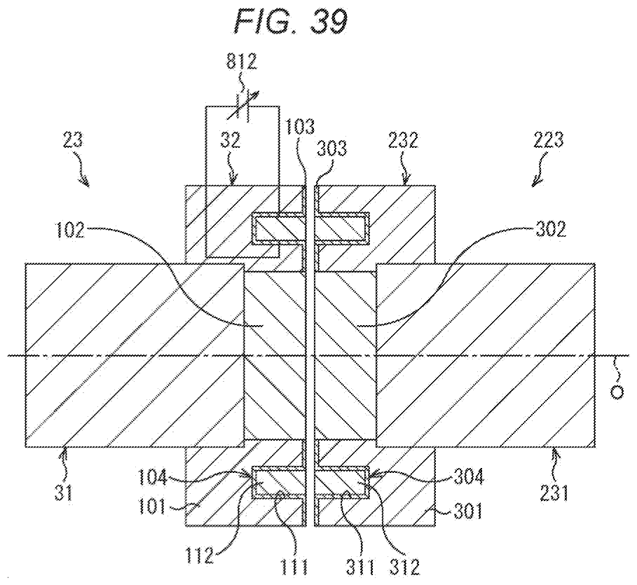

FIG. 39 illustrates a connection example of the variable power source 812. Further, in FIG. 39, parts corresponding to those in FIG. 5 are denoted by the same reference numerals, and description thereof will be omitted as appropriate.

The variable power source 812 is connected to apply the bias voltage to the dielectric 112 of the choke structure 104. As described above, the dielectric 112 includes a dielectric constant-variable material, and the dielectric constant varies as the bias voltage to be applied varies.

### First Example of Noise Reduction Process

Next, a first example of the noise reduction process executed by the communication device 801 will be described with reference to a flowchart of FIG. 40.

The flowchart of FIG. 40 differs from the flowchart of FIG. 23 only in a process of step S303. In other words, in step S303, the control unit 841 adjusts the bias voltage. Specifically, the control unit 841 adjusts the dielectric constant of the dielectric 112 of the choke structure 104 by adjusting the voltage (bias voltage) of the variable power source 812 in a direction in which the noise level is decreased.

Therefore, in the noise reduction process of FIG. 40, the effect similar to that of the noise reduction process of FIG. 23 is obtained by adjusting the bias voltage to be applied to the dielectric 112 of the choke structure 104.

### Second Example of Noise Reduction Process

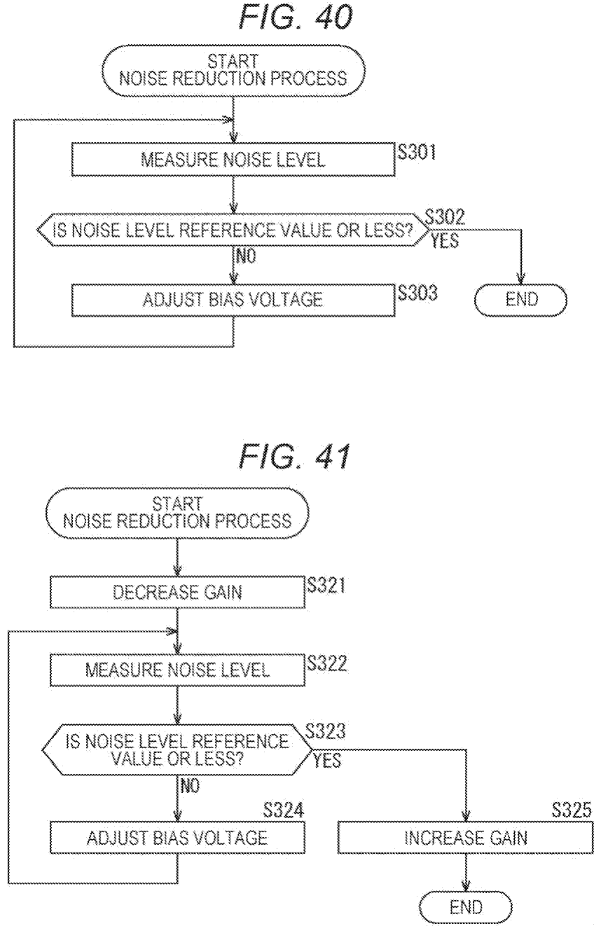

Next, a second example of the noise reduction process executed by the communication device 801 will be described with reference to a flowchart of FIG. 41.

A flowchart of FIG. 41 differs from the flowchart of FIG. 24 only in a process of step S324. In other words, in step S324, the bias voltage is adjusted, similarly to the process of step S303 of FIG. 40.

Therefore, in the noise reduction process of FIG. 41, the effect similar to that of the noise reduction process of FIG. 24 is obtained by adjusting the bias voltage applied to the dielectric 112 of the choke structure 104.

### Third Example of Noise Reduction Process

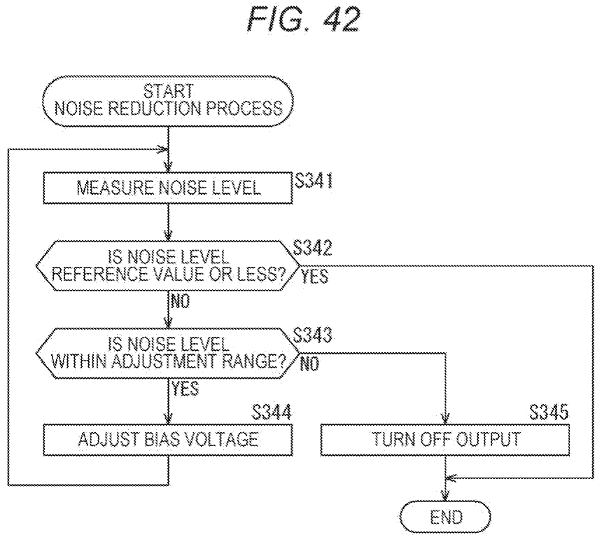

Next, a third example of the noise reduction process executed by the communication device 801 will be described with reference to a flowchart of FIG. 42.

A flowchart of FIG. 42 differs from the flowchart of FIG. 25 only in a process of step S344. In other words, in step S344, the bias voltage is adjusted, similarly to the process of step S303 of FIG. 40.

Therefore, in the noise reduction process of FIG. 42, the effect similar to that of the noise reduction process of FIG. 25 is obtained by adjusting the bias voltage to be applied to the dielectric 112 of the choke structure 104.

### Fourth Example of Noise Reduction Process

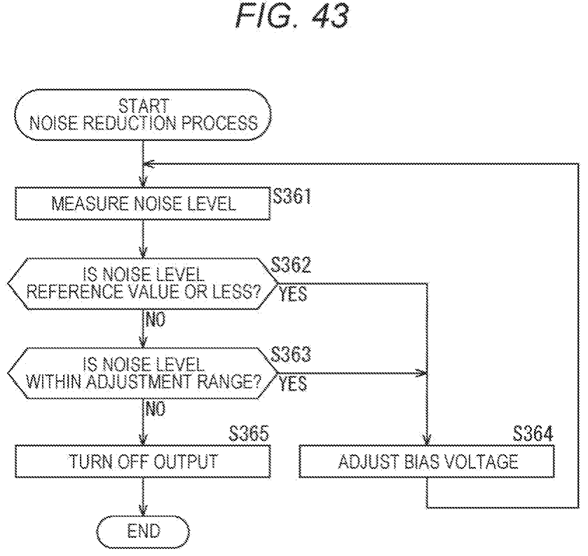

Next, a fourth example of the noise reduction process executed by the communication device 801 will be described with reference to a flowchart of FIG. 43.

A flowchart of FIG. 43 differs from the flowchart of FIG. 26 only in a process of step S364. In other words, in step S364, the bias voltage is adjusted, similarly to the process of step S303 of FIG. 40.

Therefore, in the noise reduction process of FIG. 43, the effect similar to the noise reduction process of FIG. 26 can be obtained by adjusting the bias voltage to be applied to the dielectric 112 of the choke structure 104.

### Fifth Example of Noise Reduction Process

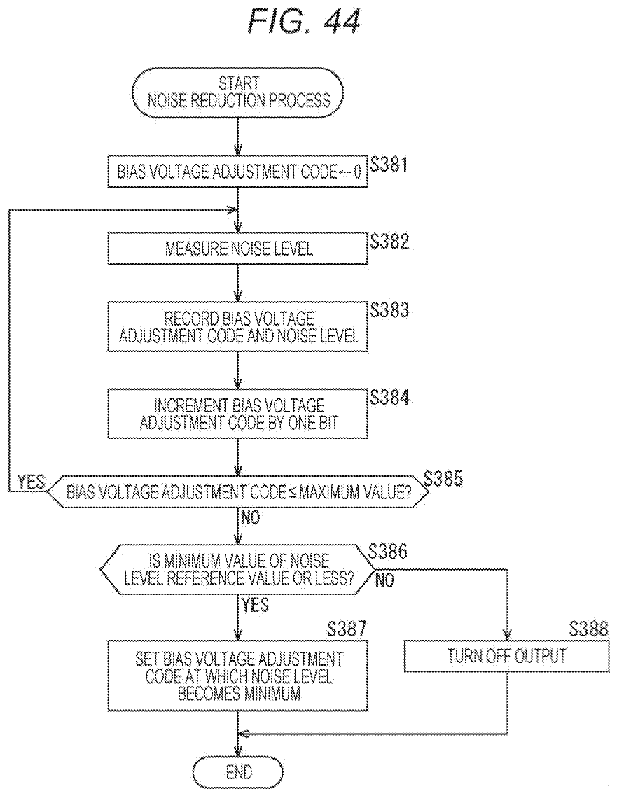

Next, a fifth example of the noise reduction process executed by the communication device 801 will be described with reference to a flowchart of FIG. 44. This process is started, for example, when the transmission of the signal from the communication device 801 to the communication device 12 is started.

In step S381, the control unit 841 sets the bias voltage adjustment code of the variable power source 812 to 0. The bias voltage adjustment code is a code for adjusting the bias voltage to be applied to the dielectric 112 of the choke structure 104 by the variable power source 812 and can be set in units of one bit. For example, as the bias voltage adjustment code is increased by one bit, the bias voltage is increased by a predetermined value. Then, the variable power source 812 applies the bias voltage corresponding to the bias voltage adjustment code to the dielectric 112.

In step S382, the noise level is measured, similarly to the process of step S11 of FIG. 23.

In step S383, the control unit 841 records the bias voltage adjustment code and the noise level measured by the power sensor 511.

In step S384, the control unit 841 increments the bias voltage adjustment code by one bit.

In step S385, the control unit 841 determines whether or not the bias voltage adjustment code is a maximum value or less. In a case where it is determined that the bias voltage adjustment code is the maximum value or less, the process returns to step S382.

Thereafter, the process of step S382 to step S385 is repeatedly executed until it is determined in step S385 that the bias voltage adjustment code exceeds the maximum value. Accordingly, the noise level is measured and recorded while varying the bias voltage to be applied to the dielectric 112 of the choke structure 104 at predetermined intervals.

On the other hand, in a case where it is determined in step S385 that the bias voltage adjustment code exceeds the maximum value, the process proceeds to step S386.

In step S386, it is determined whether or not the minimum value of the noise level is a reference value or less, similarly to the process of step S96 of FIG. 27. In a case where it is determined that the minimum value of the noise level is the reference value or less, the process proceeds to step S387.

In step S387, the control unit 841 sets the bias voltage adjustment code at which the noise level becomes minimum. In other words, the control unit 841 sets the bias voltage adjustment code of the variable power source 812 to the bias voltage adjustment code when the measurement value of the noise level becomes minimum. Accordingly, the dielectric constant of the dielectric 112 is set near the dielectric constant at which the radiation noise reduction effect by the choke structure 104 is highest at the current distance between the connectors and the transmission frequency. Then, the radiation noise is suppressed to be as small as possible.

Thereafter, the noise reduction process ends.

On the other hand, in a case where it is determined in step S386 that the minimum value of the noise level exceeds the reference value, the process proceeds to step S388.

In step S388, the output is turned off, similarly to the process of step S55 of FIG. 25.

Thereafter, the noise reduction process ends.

### Second Example

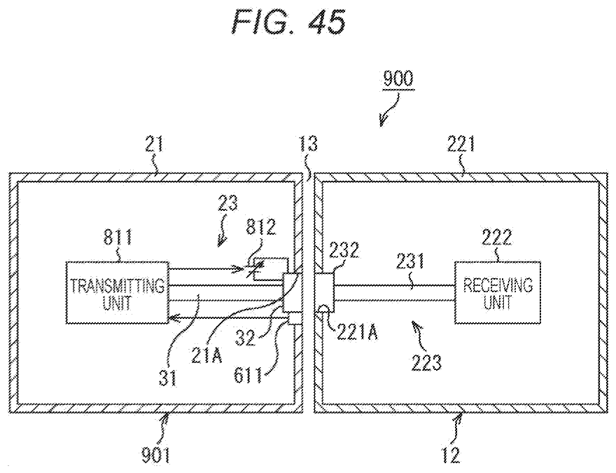

Next, a second example of the third embodiment of the present technology will be described with reference to FIGS. 45 to 47.

FIG. 45 is a plane view including a partial cross section illustrating an example of a configuration of a communication system according to the second example of the third embodiment of the present technology. Further, in FIG. 45, parts corresponding to those in FIGS. 30 and 37 are denoted by the same reference numerals, and description thereof will be omitted as appropriate.

A communication system 900 of FIG. 45 differs from the communication system 800 of FIG. 37 in that a communication device 901 is disposed instead of the communication device 801. The communication device 901 differs from the communication device 801 in that the distance sensor 611 is disposed instead of the power sensor 511, similarly to the communication device 601 in FIG. 30.

The transmitting unit 811 adjusts the dielectric constant of the dielectric 112 of the choke structure 104 of the coupling portion 32 so that the radiation noise is reduced by adjusting the voltage of the variable power source 812 on the basis of the measurement result of the distance sensor 611 as described later.

### First Example of Noise Reduction Process

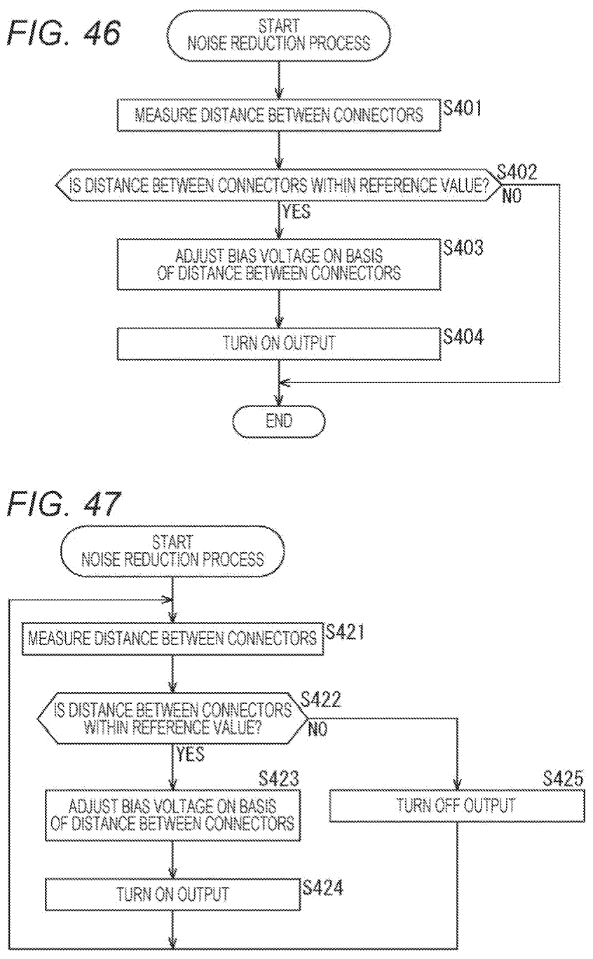

Next, a first example of the noise reduction process executed by the communication device 901 will be described with reference to a flowchart of FIG. 46.

A flowchart of FIG. 46 differs from the flowchart of FIG. 31 only in the process of step S403. In other words, in step S403, the control unit 841 adjusts the bias voltage on the basis of the distance between the connectors. For example, the control unit 841 holds data indicating the dielectric constant of the dielectric 112 of the choke structure 104 at which the radiation noise becomes minimum at a combination of the distance between the connectors and the transmission frequency. Then, on the basis of the data, the control unit 841 detects the dielectric constant of the dielectric 112 at which the radiation noise becomes minimum at the current distance between the connectors and the transmission frequency. Further, the control unit 841 adjusts the bias voltage of the variable power source 812 so that it becomes the dielectric constant detected by the dielectric 112.

Therefore, in the noise reduction process of FIG. 46, the effect similar to that of the noise reduction process of FIG. 31 can be obtained by adjusting the bias voltage applied to the dielectric 112.

### Second Example of Noise Reduction Process

Next, a second example of the noise reduction process executed by the communication device 901 will be described with reference to a flowchart of FIG. 47.

A flowchart of FIG. 47 differs from the flowchart of FIG. 32 only in the process of step S423. In other words, in step S423, the bias voltage is adjusted on the basis of the distance between the connectors, similarly to the process of step S403 of FIG. 46.

Therefore, in the noise reduction process of FIG. 47, the effect similar to that of the noise reduction process of FIG. 32 can be obtained by adjusting the bias voltage applied to the dielectric 112.

### Third Example

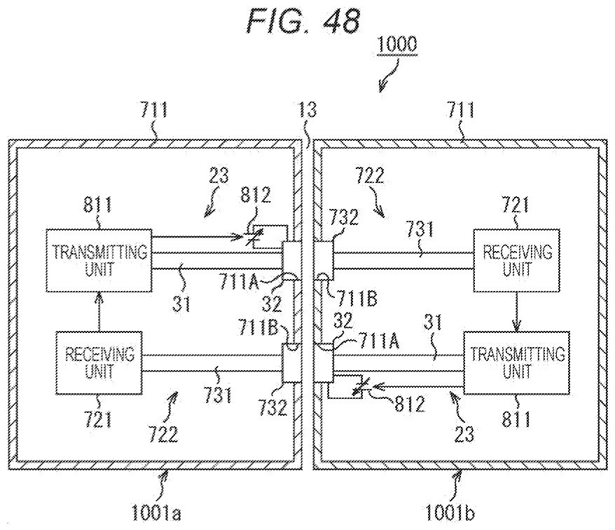

Next, a third example of the third embodiment of the present technology will be described with reference to FIG. 48.

FIG. 48 is a plane view including a partial cross section illustrating an example of a configuration of a communication system according to the third example of the third embodiment of the present technology. Further, in FIG. 48, parts corresponding to those in FIGS. 33 and 37 are denoted by the same reference numerals, and description thereof will be omitted as appropriate.

A communication system 1000 of FIG. 48 differs from the communication system 700 of FIG. 33 in that a communication device 1001a and a communication device 1001b are disposed instead of the communication device 701a and the communication device 701b. The communication device 1001a differs from the communication device 701a in that a transmitting unit 811 is disposed instead of the transmitting unit 512, and the variable power source 812 is added.

The communication device 1001b has the same configuration as the communication device 1001a.

The communication device 1001a and the communication device 1001b can perform two-way communication. Further, the communication device 1001a and the communication device 1001b can use the receiving unit 721 instead of the power sensor 511 of the communication device 801 in FIG. 37. Therefore, the communication device 1001a and the communication device 1001b can suppress the radiation noise by adjusting the bias voltage of the dielectric 112 of the choke structure 104 on the basis of the level of the radiation noise, similarly to the case of the communication device 801 in FIG. 37.

### 5. Modified Example

Although the preferred embodiments of the present technology have been described above, the present technology is not limited to the above embodiments, and various modifications or improvements may be made to the above embodiments within the scope of the gist of the present technology.

For example, in the above embodiments, the waveguide tube 23 of the communication device 11 or the like and the waveguide tube 223 of the communication device 12 or the like have the transmission path portion 31 and the transmission path portion 231 of a predetermined length. However, the length of the transmission path portion 31 and the transmission path portion 231 is arbitrary, and there are cases in which the length is 0, that is, the transmission path portion 31 and the transmission path portion 231 are not disposed. Even in this case, apart of the waveguide on the input side of the coupling portion 32 doubles as the transmission path portion 31, and a part of the waveguide on the output side of the coupling portion 232 doubles as the transmission path portion 231.

Further, the transmission path portion 31 and the transmission path portion 231 can be regarded as a waveguide tube including a coupling portion 32 and a coupling portion 232 in a leading end portion thereof. In this case, the connector device of the present technology is a connector device including a waveguide tube (waveguide tube 31/waveguide tube 231) which includes a coupling portion (coupling portion 32/coupling portion 232) in a leading end portion, is arranged in a state in which an opening end thereof is in contact with or close to another waveguide tube including a coupling portion in a leading end portion, and transmits a radio frequency signal.

The same applies to the waveguide tube 722 of the communication device 701a, the communication device 701b, the communication device 1001a, or the communication device 1001b.

Further, the second and third embodiments of the present technology may be combined. In other words, it is possible to adjust the frequency characteristic of the choke structure by adjusting the transmission frequency of the transmission signal and adjusting the dielectric constant of the dielectric of the choke structure of the waveguide tube in the communication device on the transmitting side.

Further, in the second embodiment of the present technology, it is possible to delete the choke structure of the coupling portion of one waveguide tube out of the communication device on the transmitting side and the communication device on the receiving side. Further, in the third embodiment of the present technology, it is possible to delete the choke structure of the coupling portion of the waveguide tube of the communication device on the receiving side.

Further, for example, in the second embodiment of the present technology, the transmission frequency may be adjusted on the basis of both the distance between the connectors and the level of the radiation noise. In this case, for example, in the communication device 501 of FIG. 21 or the communication devices 701a and 701b of FIG. 33, the distance sensor 611 is disposed to measure the distance between the connectors.

Further, for example, in the third embodiment of the present technology, the dielectric constant of the dielectric 112 of the choke structure 104 may be adjusted on the basis of both the distance between the connectors and the level of the radiation noise. In this case, for example, in the communication device 801 of FIG. 37 or the communication devices 1001a and 1001b of FIG. 48, the distance sensor 611 is disposed to measure the distance between the connectors.

### 6. Specific Example of Communication System

The following combinations are considered as a combination of electronic devices using the communication device 11 and the communication device 12, the communication device 501 and the communication device 12, the communication device 601 and the communication device 12, the communication device 701a and the communication device 701b, the communication device 801 and the communication device 12, the communication device 901 and the communication device 12, or the communication device 1001a and the communication device 1001b. Here, the combinations described below are merely examples, and the present technology is not limited to the following combinations. It should be noted that a one-direction (one-way) transmission scheme or a two-way transmission scheme may be used as a signal transmission scheme between the two communication devices.

A combination in which, in a case where an electronic device using the communication device 12, the communication device 701b, or the communication device 1001b is a battery-driven device such as a mobile phone, a digital camera, a video camera, a game machine, a remote controller, or the like, an electronic device using the communication device 11, the communication device 501, the communication device 601, the communication device 701a, the communication device 801, the communication device 901, or the communication device 1001a is a device which serves as a battery charger or performs image processing and is called a so-called base station is considered. Further, a combination in which, in a case where an electronic device using the communication device 12, the communication device 701b, or the communication device 1001b is a device having an appearance such as a relatively thin IC card, an electronic device using the communication device 11, the communication device 501, the communication device 601, the communication device 701a, the communication device 801, the communication device 901, or the communication device 1001a is a card reading/writing device is considered. The card reading/writing device is further used in combination with an electronic device main body such as a digital recording/reproducing device, a terrestrial television receiver, a mobile phone, a game machine, a computer, or the like.

Further, a combination of a mobile terminal device and a cradle may be considered. The cradle is a stand type expansion device which performs charging, data transfer, or extension on the mobile terminal device. In the communication system with the above-described system configuration, an electronic device using the communication device 11, the communication device 501, the communication device 601, the communication device 701a, the communication device 801, the communication device 901, or the communication device 1001a including the transmitting unit 22, the transmitting unit 512, or the transmitting unit 811 that transmits the signal of the millimeter wave band serves as the cradle. Further, an electronic device using the communication device 12, the communication device 701b, or the communication device 1001b including the receiving unit 222 or the receiving unit 721 which receives the signal of the millimeter wave band serves as the mobile terminal device.

Further, for example, a signal processing unit or the like that processes a signal to be transmitted, a received signal, or the like is disposed in each communication device or an electronic device including each communication device.

Further, a series of processes described above can be executed by hardware or software.

Further, in a case where a series of processes is executed by software, the program executed by the computer may be a program in which processes are performed chronologically in accordance with the order described in this description, or a program in which processes are performed in parallel or at a necessary timing such as a timing at which calling is performed.

Further, in this description, a system means a set of a plurality of components (apparatuses, modules (parts), or the like), and it does not matter whether or not all the components are in a single housing. Therefore, a plurality of apparatuses which are accommodated in separate housings and connected via a network and a single apparatus in which a plurality of modules are accommodated in a single housing are both systems.

Further, the embodiments of the present technology are not limited to the above-described embodiments, and various modifications can be made without departing from the gist of the present technology.

For example, the present technology can have a configuration of cloud computing in which one function is shared and collaboratively processed by a plurality of devices via a network.

Further, the respective steps described in the flowchart described above can be executed by a single apparatus or can be shared and executed by a plurality of apparatuses.

Further, in a case where a plurality of processes are included in one step, a plurality of processes included in one step can be executed by a single apparatus or shared and executed by a plurality of apparatuses.

Further, the effects described in this description are merely examples and not limited, and other effects may be included.

Further, for example, the present technology can have the following configurations.

(1) A communication device, including:

a first waveguide tube that includes a choke structure nearby an opening end and transmits a signal in a state in which the opening end is in contact with or close to an opening end of a first other waveguide tube; and

a transmitting unit that transmits a transmission signal via the first waveguide tube and controls a relative relation between a transmission frequency of the transmission signal and a frequency characteristic of the choke structure.

(2) The communication device according to (1), in which the transmitting unit adjusts the transmission frequency on the basis of at least one of a level of a leakage electromagnetic wave which is an electromagnetic wave leaking between the first waveguide tube and the first other waveguide tube or a distance between the first waveguide tube and the first other waveguide tube.

(3) The communication device according to (2), in which the transmitting unit sets the transmission frequency to be near a frequency at which an effect of reducing the leakage electromagnetic wave by the choke structure is highest at the distance between the first waveguide tube and the first other waveguide tube.

(4) The communication device according to (2) or (3), in which the transmitting unit further adjusts a gain of an amplifier that amplifies the transmission signal on the basis of the level of the leakage electromagnetic wave.

(5) The communication device according to any of (2) to (4), further including:

a second waveguide tube that transmits a signal in a state in which an opening end is in contact with or close to an opening end of a second other waveguide tube; and

a receiving unit that receives a signal via the second waveguide tube,

in which the transmitting unit adjusts the transmission frequency on the basis of the level of the leakage electromagnetic wave received via the second waveguide tube by the receiving unit.

(6) The communication device according to any of (2) to (4), further including a first measuring unit that measures the level of the leakage electromagnetic wave.

(7) The communication device according to any of (2) to (6), further including a second measuring unit that measures the distance between the first waveguide tube and the first other waveguide tube.

(8) The communication device according to (1), in which a groove of the choke structure is filled with a dielectric including a dielectric constant-variable material, and

the transmitting unit adjusts a dielectric constant of the dielectric.

(9) The communication device according to (8), in which the transmitting unit adjusts the dielectric constant of the dielectric on the basis of at least one of a level of a leakage electromagnetic wave which is an electromagnetic wave leaking between the first waveguide tube and the first other waveguide tube or a distance between the first waveguide tube and the first other waveguide tube.

(10) The communication device according to (9), in which the transmitting unit sets the dielectric constant of the dielectric to be near a dielectric constant at which an effect of reducing the leakage electromagnetic wave by the choke structure is highest at the distance between the first waveguide tube and the first other waveguide tube and the transmission frequency.

(11) The communication device according to (9) or (10), in which the transmitting unit further adjusts a gain of an amplifier that amplifies the transmission signal on the basis of the level of the leakage electromagnetic wave.

(12) The communication device according to any of (9) to (11), further including:

a second waveguide tube that transmits a signal in a state in which an opening end is in contact with or close to an opening end of a second other waveguide tube; and

a receiving unit that receives a signal via the second waveguide tube,

in which the transmitting unit adjusts the dielectric constant of the dielectric on the basis of the level of the leakage electromagnetic wave received via the second waveguide tube by the receiving unit.

(13) The communication device according to any of (9) to (11), further including a first measuring unit that measures the level of the leakage electromagnetic wave.

(14) The communication device according to any of (9) to (13), further including a second measuring unit that measures the distance between the first waveguide tube and the first other waveguide tube.

(15) The communication device according to any of (8) to (14), in which the transmitting unit adjusts the dielectric constant of the dielectric by adjusting a voltage to be applied to the dielectric.

(16) The communication device according to any of (8) to (15), in which a depth of the groove of the choke structure is about ¼ of a wavelength of the transmission signal.

(17) The communication device according to any of (1) to (16), in which the transmission signal is a signal of a millimeter wave band.

(18) A communication method, including:

controlling, by a communication device including a waveguide tube including a choke structure nearby an opening end, a relative relation between a transmission frequency of a transmission signal and a frequency characteristic of the choke structure in a case where the transmission signal is transmitted from the waveguide tube to another waveguide tube in a state in which the opening end of the waveguide tube is in contact with or close to an opening end of the other waveguide tube.

(19) An electronic device, including:

a waveguide tube that includes a choke structure nearby an opening end and transmits a signal in a state in which the opening end is in contact with or close to an opening end of another waveguide tube; and

a transmitting unit that transmits a transmission signal via the waveguide tube and controls a relative relation between a transmission frequency of the transmission signal and a frequency characteristic of the choke structure.

### REFERENCE SIGNS LIST

10 Communication system
11 Communication device
12 Communication device
22 Transmitting unit
23 Waveguide tube
51 Signal generating unit
61 Oscillating unit
63 Power amplifier
104 Choke structure
111 Groove
112 Dielectric
500 Communication system
501 Communication device
511 Power sensor
512 Transmitting unit
532 Signal generating unit
541 Control unit
600 Communication system
601 Communication device
611 Distance sensor
700 Communication system
701a, 701b Communication device
721 Receiving unit
722 Waveguide tube
732 Connecting unit
800 Communication system
801 Communication device
811 Transmitting unit
812 Variable power source
831 Signal generating unit
841 Control unit
900 Communication system
901 Communication device
1000 Communication system
1001a, 1001b Communication device

1. A communication device, comprising:
a first waveguide tube that includes a choke structure nearby an opening end and transmits a signal in a state in which the opening end is in contact with or close to an opening end of a first other waveguide tube; and
a transmitting unit that transmits a transmission signal via the first waveguide tube and controls a relative relation between a transmission frequency of the transmission signal and a frequency characteristic of the choke structure.

2. The communication device according to claim 1, wherein the transmitting unit adjusts the transmission frequency on a basis of at least one of a level of a leakage electromagnetic wave which is an electromagnetic wave leaking between the first waveguide tube and the first other waveguide tube or a distance between the first waveguide tube and the first other waveguide tube.

3. The communication device according to claim 2, wherein the transmitting unit sets the transmission frequency to be near a frequency at which an effect of reducing the leakage electromagnetic wave by the choke structure is highest at the distance between the first waveguide tube and the first other waveguide tube.

4. The communication device according to claim 2, wherein the transmitting unit further adjusts a gain of an amplifier that amplifies the transmission signal on a basis of the level of the leakage electromagnetic wave.

5. The communication device according to claim 2, further comprising:
a second waveguide tube that transmits a signal in a state in which an opening end is in contact with or close to an opening end of a second other waveguide tube; and
a receiving unit that receives a signal via the second waveguide tube,
wherein the transmitting unit adjusts the transmission frequency on a basis of the level of the leakage electromagnetic wave received via the second waveguide tube by the receiving unit.

6. The communication device according to claim 2, further comprising a first measuring unit that measures the level of the leakage electromagnetic wave.

7. The communication device according to claim 2, further comprising a second measuring unit that measures the distance between the first waveguide tube and the first other waveguide tube.

8. The communication device according to claim 1, wherein a groove of the choke structure is filled with a dielectric including a dielectric constant-variable material, and
the transmitting unit adjusts a dielectric constant of the dielectric.

9. The communication device according to claim 8, wherein the transmitting unit adjusts the dielectric constant of the dielectric on a basis of at least one of a level of a leakage electromagnetic wave which is an electromagnetic wave leaking between the first waveguide tube and the first other waveguide tube or a distance between the first waveguide tube and the first other waveguide tube.

10. The communication device according to claim 9, wherein the transmitting unit sets the dielectric constant of the dielectric to be near a dielectric constant at which an effect of reducing the leakage electromagnetic wave by the choke structure is highest at the distance between the first waveguide tube and the first other waveguide tube and the transmission frequency.

11. The communication device according to claim 9, wherein the transmitting unit further adjusts a gain of an amplifier that amplifies the transmission signal on a basis of the level of the leakage electromagnetic wave.

12. The communication device according to claim 9, further comprising:
a second waveguide tube that transmits a signal in a state in which an opening end is in contact with or close to an opening end of a second other waveguide tube; and
a receiving unit that receives a signal via the second waveguide tube,
wherein the transmitting unit adjusts the dielectric constant of the dielectric on a basis of the level of the leakage electromagnetic wave received via the second waveguide tube by the receiving unit.

13. The communication device according to claim 9, further comprising a first measuring unit that measures the level of the leakage electromagnetic wave.

14. The communication device according to claim 9, further comprising a second measuring unit that measures the distance between the first waveguide tube and the first other waveguide tube.

15. The communication device according to claim 8, wherein the transmitting unit adjusts the dielectric constant of the dielectric by adjusting a voltage to be applied to the dielectric.

16. The communication device according to claim 8, wherein a depth of the groove of the choke structure is about ¼ of a wavelength of the transmission signal.

17. The communication device according to claim 1, wherein the transmission signal is a signal of a millimeter wave band.

18. A communication method, comprising:
controlling, by a communication device including a waveguide tube including a choke structure nearby an opening end, a relative relation between a transmission frequency of a transmission signal and a frequency characteristic of the choke structure in a case where the transmission signal is transmitted from the waveguide tube to another waveguide tube in a state in which the opening end of the waveguide tube is in contact with or close to an opening end of the other waveguide tube.

19. An electronic device, comprising:
a waveguide tube that includes a choke structure nearby an opening end and transmits a signal in a state in which the opening end is in contact with or close to an opening end of another waveguide tube; and
a transmitting unit that transmits a transmission signal via the waveguide tube and controls a relative relation between a transmission frequency of the transmission signal and a frequency characteristic of the choke structure.
